(19) United States
(12) Patent Application Publication
(10) Pub. No.: US 2024/0151360 A1
(43) Pub. Date: May 9, 2024

(54) HYDROGEN SUPPLY MODULE AND HYDROGEN SUPPLY METHOD

(71) Applicants: HYUNDAI MOTOR COMPANY, Seoul (KR); KIA CORPORATION, Seoul (KR)

(72) Inventors: Ho Young Jeong, Daegu (KR); Hoon Mo Park, Seongnam-si (KR); Kyung Moon Lee, Uiwang-si (KR); Yeon Ho Kim, Seoul (KR); Ji Hye Park, Seoul (KR); Jae Yeon Kim, Hwaseong-si (KR); Dong Hoon Nam, Suwon-si (KR)

(73) Assignees: HYUNDAI MOTOR COMPANY, Seoul (KR); KIA CORPORATION, Seoul (KR)

(21) Appl. No.: 18/239,946

(22) Filed: Aug. 30, 2023

(30) Foreign Application Priority Data
Nov. 9, 2022 (KR) 10-2022-0148800

(51) Int. Cl. F17C 7/02

(52) U.S. Cl. CPC F17C 7/02; F17C 2205/0323; F17C 2205/0352; F17C 2221/012; F17C 2227/0135; F17C 2227/0157; F17C 2227/0185; F17C 2227/0323; F17C 2227/0355; F17C 2250/0636; F17C 2265/06

(57) ABSTRACT

A hydrogen supply method includes a two-side heat exchange mode in which both introducing a second fluid into a hydrogen storage part after the second fluid exchanges heat with a first fluid in a second heat exchanger in a state in which a compressor is driven to compress the first fluid and introducing the second fluid into the hydrogen storage part after the second fluid is heated or cooled in the thermal device are performed. The method also includes a one-side heat exchange mode in which one of introducing the second fluid into the hydrogen storage part after the second fluid exchanges heat with the first fluid in the second heat exchanger in a state in which the compressor is driven to compress the first fluid and introducing the second fluid into the hydrogen storage part after the second fluid is heated or cooled in the thermal device is performed.

### CROSS-REFERENCE TO RELATED APPLICATION

This application claims the benefit of and priority to Korean Patent Application No. 10-2022-0148800, filed in the Korean Intellectual Property Office on Nov. 9, 2022, the entire contents of which are incorporated herein by reference.

### TECHNICAL FIELD

The present disclosure relates to a hydrogen supply module and a hydrogen supply method, and more particularly, to a hydrogen supply module and a hydrogen supply method in which hydrogen may be stored and then be supplied to a source of demand.

### BACKGROUND

In recent years, due to climate changes, clean energy sources that may replace existing energy sources have been increasing in popularity. Hydrogen energy sources are being spotlighted as one of the clean energy sources. To use hydrogen as an energy source, a technology for producing and storing hydrogen and supplying the hydrogen to a source of demand is important.

To achieve this, according to a conventional technology, when a hydrogen storage system that stores hydrogen is used, hydrogen is typically compressed in a gaseous state by using a compressor driven by electric energy. The compressed hydrogen is stored and is then supplied to a source of demand that requires the hydrogen.

However, due to characteristics of hydrogen, a volume of which is remarkably larger than volumes of other gases, in a conventional hydrogen storage system, it is necessary to compress hydrogen at a high pressure. Accordingly, in the conventional hydrogen storage, a scheme of compressing hydrogen through multi-stage compression and storing the compressed hydrogen has been widely used. As a result, electric energy that is necessary for storing hydrogen in a conventional hydrogen storage system is excessive. Further, costs for maintaining the conventional hydrogen storage system are also excessive.

### SUMMARY

The present disclosure has been made to solve the above-mentioned problems occurring in the prior art while advantages achieved by the prior art are maintained intact.

An aspect of the present disclosure provides a hydrogen storage system of a new form that may replace a hydrogen storage system that directly compresses hydrogen.

The technical problems to be solved by the present disclosure are not limited to the aforementioned problems. Other technical problems not mentioned herein can be clearly understood from the following description by those having ordinary skill in the art to which the present disclosure pertains.

According to an aspect of the present disclosure, a hydrogen supply module includes a first circulation part including a first fluid circulation line in which a first fluid circulates and a second circulation part including a second fluid circulation line in which a second fluid circulates. The first fluid circulation part includes a first heat exchanger in which the first fluid exchanges heat with an external fluid. The first fluid circulation part also includes: a first flow rate control member connected to the first heat exchanger through the first fluid circulation line and that controls flows of the first fluid; and a compressor connected to the first flow rate control member through the first fluid circulation line and that compresses the first fluid. The first fluid circulation part additionally includes: a second heat exchanger connected to the first flow rate control member through the first fluid circulation line; and an expansion member connected to the second heat exchanger through the first fluid circulation line and that expands the first fluid. The second fluid circulation line is connected to the second heat exchanger such that the first fluid and the second fluid exchange heat in the second heat exchanger. The second fluid circulation part includes a pump connected to the second heat exchanger through the second fluid circulation line and that pumps the second fluid. The second fluid circulation part also includes a hydrogen storage part connected to the second heat exchanger through the second fluid circulation line and including a metal or an alloy that absorbs hydrogen. The second fluid circulation part further includes a second flow rate control member provided on the second fluid circulation line and that controls flows of the second fluid that flows on the second fluid circulation line. The hydrogen storage part includes: a first hydrogen storage part provided on the second fluid circulation line; and a second hydrogen storage part provided on the second fluid circulation line and connected to the first hydrogen storage part through the second fluid circulation line while the second flow rate control member is interposed therebetween.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one end and an opposite end of the second flow rate control member and having a closed loop shape. The second fluid circulation line may additionally include a (2-4)-th fluid circulation line connecting the second hydrogen storage part and the second flow rate control member and having a closed loop shape. The second flow rate control member may be configured to control flow directions of the second fluid in the (2-1)-th fluid circulation line, the (2-2)-th fluid circulation line, and the (2-3)-th fluid circulation line, and the (2-4)-th fluid circulation line.

The pump may include a first pump provided on the (2-2)-th fluid circulation line, and a second pump provided on the (2-4)-th fluid circulation line.

A first side and a second side of the first flow rate control member may be connected to the compressor through the first fluid circulation line. The first fluid circulation part may be configured to control the flows of the first fluid such that the first fluid 1) sequentially passes through the first flow rate control member, the compressor, the first flow rate control member, and the second heat exchanger, or ii) sequentially passes through the first flow rate control member, the compressor, the first flow rate control member, and the first heat exchanger.

The second fluid circulation part may further include a thermal device provided on the (2-3)-th fluid circulation line and that heats or cools the second fluid. The thermal device may be a heat dissipating member that cools the second fluid.

The second fluid circulation part may further include a thermal device provided on the (2-3)-th fluid circulation line and that heats or cools the second fluid. The thermal device may be a heating member that heats the second fluid.

According to another aspect of the present disclosure, a hydrogen supply method uses a hydrogen supply module that includes a first circulation part including a first fluid circulation line in which a first fluid circulates and a second circulation part including a second fluid circulation line in which a second fluid circulates. The second fluid circulation part includes a thermal device provided on the second fluid circulation line. The hydrogen supply method includes performing, in a two-side heat exchange mode, both i) introducing the second fluid into a hydrogen storage part after the second fluid exchanges heat with the first fluid in a second heat exchanger in a state in which the compressor is driven to compress the first fluid and ii) introducing the second fluid into the hydrogen storage part after the second fluid is heated or cooled in the thermal device. The hydrogen supply method also includes performing, in a one-side heat exchange mode one of i) introducing the second fluid into the hydrogen storage part after the second fluid exchanges heat with the first fluid in the second heat exchanger in a state in which the compressor is driven to compress the first fluid and ii) introducing the second fluid into the hydrogen storage part after the second fluid is heated or cooled in the thermal device is performed. The two-side heat exchange mode and the one-side heat exchange mode may be time-sequentially performed at separate time periods. The first fluid circulation part of the hydrogen supply module includes: a first heat exchanger in which the first fluid exchanges heat with an external fluid, a first flow rate control member connected to the first heat exchanger through the first fluid circulation line and configured to control flows of the first fluid, a compressor connected to the first flow rate control member through the first fluid circulation line and configured to compress the first fluid, the second heat exchanger connected to the first flow rate control member through the first fluid circulation line, and an expansion member connected to the second heat exchanger through the first fluid circulation line and configured to expand the first fluid. The second fluid circulation line is connected to the second heat exchanger such that the first fluid and the second fluid exchange heat in the second heat exchanger. The second fluid circulation part of the hydrogen supply module includes a pump connected to the second heat exchanger through the second fluid circulation line and configured to pump the second fluid, a hydrogen storage part connected to the second heat exchanger through the second fluid circulation line and including a metal or an alloy that absorbs hydrogen, and a second flow rate control member provided on the second fluid circulation line and configured to control flows of the second fluid that flows on the second fluid circulation line. The hydrogen storage part of the hydrogen supply module includes a first hydrogen storage part provided on the second fluid circulation line, and a second hydrogen storage part provided on the second fluid circulation line and connected to the first hydrogen storage part through the second fluid circulation line while the second flow rate control member is interposed therebetween.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a close loop shape. The thermal device may be provided on the (2-3)-th fluid circulation line. The two-side heat exchange mode may include a (1-1)-th fluid circulation operation of the first fluid sequentially circulating in the first heat exchanger, the compressor, the second heat exchanger, and the expansion member through the first fluid circulation line, and a (2-1)-th fluid circulation operation of the second fluid being introduced into the second heat exchanger through the (2-1)-th fluid circulation line to exchange heat with the first fluid so as to be heated and then being introduced into the first hydrogen storage part through the (2-2)-th fluid circulation line to heat the first hydrogen storage part.

The two-side heat exchange mode may further include a (2-2)-th fluid circulation operation of the second fluid being introduced into the thermal device through the (2-3)-th fluid circulation line to be cooled and then being introduced into the second hydrogen storage part through the (2-4)-th fluid circulation line to cool the second hydrogen storage part.

The two-side heat exchange mode may further include a (2-3)-th fluid circulation operation of the second fluid being introduced into the second heat exchanger through the (2-1)-th fluid circulation line to exchange heat with the first fluid so as to be heated and then being introduced into the second hydrogen storage part through the (2-4)-th fluid circulation line to heat the second hydrogen storage part.

The two-side heat exchange mode may further include a (2-4)-th fluid circulation operation of the second fluid being introduced into the thermal device through the (2-3)-th fluid circulation line to be cooled and then being introduced into the first hydrogen storage part through the (2-2)-th fluid circulation line to cool the first hydrogen storage part.

The (2-1)-th fluid circulation operation and the (2-2)-th fluid circulation operation may be performed in a time-sequentially overlapping state, the (2-3)-th fluid circulation operation and the (2-4)-th fluid circulation operation may be performed in a time-sequentially overlapping state, and the (2-3)-th fluid circulation operation and the (2-4)-th fluid circulation operation may be performed after the (2-1)-th fluid circulation operation and the (2-2)-th fluid circulation operation.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member. The thermal device may be provided on the (2-3)-th fluid circulation line. The one-side heat exchange mode may further include a (1-1)-th fluid circulation operation of the first fluid sequentially circulating in the first heat exchanger, the compressor, the second heat exchanger, and the expansion member through the first fluid circulation line, and a (2-5)-th circulation operation of the second fluid being introduced into the second heat exchanger through the (2-1)-th fluid circulation line to exchange heat with the first fluid to be heated and then being introduced into the first hydrogen storage part and the second hydrogen storage part through the (2-2)-th fluid circulation line and the (2-4)-th fluid circulation line to heat the first hydrogen storage part and the second hydrogen storage part.

In the (2-5)-th fluid circulation operation, flows of the second fluid may be substantially stopped in the (2-3)-th fluid circulation line.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a closed loop shape. The thermal device may be provided on the (2-3)-th fluid circulation line. The two-side heat exchange mode may include a (1-2)-th fluid circulation operation of the first fluid sequentially circulating in the first heat exchanger, the expansion member, the second heat exchanger, and the compressor through the first fluid circulation line, and a (2-6)-th circulation operation of the second fluid being introduced into the second heat exchanger through the (2-1)-th fluid circulation line to exchange heat with the first fluid to be cooled and then being introduced into the first hydrogen storage part or the second hydrogen storage part through the (2-2)-th fluid circulation line or the (2-4)-th fluid circulation line to cool the first hydrogen storage part or the second hydrogen storage part.

The two-side heat exchange mode may further include a (2-7)-th circulation operation of the second fluid being cooled in the thermal device through the (2-3)-th fluid circulation line and then being introduced into the first hydrogen storage part or the second hydrogen storage part through the (2-2)-th fluid circulation line or the (2-4)-th fluid circulation line to cool the first hydrogen storage part or the second hydrogen storage part.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a closed loop shape. The thermal device may be provided on the (2-3)-th fluid circulation line. The one-side heat exchange mode may include a (1-2)-th fluid circulation operation of the first fluid sequentially circulating in the first heat exchanger, the expansion member, the second heat exchanger, and the compressor through the first fluid circulation line, and a (2-8)-th circulation operation of the second fluid being introduced into the second heat exchanger through the (2-1)-th fluid circulation line to exchange heat with the first fluid to be cooled and then being introduced into the first hydrogen storage part and the second hydrogen storage part through the (2-2)-th fluid circulation line and the (2-4)-th fluid circulation line to cool the first hydrogen storage part and the second hydrogen storage part, and in the (2-8)-th fluid circulation operation, flows of the second fluid may be substantially stopped in the (2-3)-th fluid circulation line.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a closed loop shape. The thermal device may be provided on the (2-3)-th fluid circulation line. The one-side heat exchange mode may include a (2-9)-th circulation operation of the second fluid being cooled in the thermal device through the (2-3)-th fluid circulation line and then being introduced into the first hydrogen storage part and the second hydrogen storage part through the (2-2)-th fluid circulation line and the (2-4)-th fluid circulation line to cool the first hydrogen storage part and the second hydrogen storage part, and in the (2-9)-th fluid circulation operation, the flows of the first fluid in the first fluid circulation line and the second fluid in the (2-1)-th fluid circulation line may be substantially stopped.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a closed loop shape. The thermal device may be provided on the (2-3)-th fluid circulation line. The two-side heat exchange mode may further include a (1-2)-th fluid circulation operation of the first fluid sequentially circulating in the first heat exchanger, the expansion member, the second heat exchanger, and the compressor through the first fluid circulation line, and a (2-1)-th fluid circulation operation of the second fluid being introduced into the second heat exchanger through the (2-1)-th fluid circulation line to exchange heat with the first fluid so as to be cooled and then being introduced into the first hydrogen storage part through the (2-2)-th fluid circulation line to cool the first hydrogen storage part.

The two-side heat exchange mode may further include a (2-2)-th fluid circulation operation of the second fluid being introduced into the thermal device through the (2-3)-th fluid circulation line to be heated and then being introduced into the second hydrogen storage part through the (2-4)-th fluid circulation line to heat the second hydrogen storage part.

The two-side heat exchange mode may further include a (2-3)-th fluid circulation operation of the second fluid being introduced into the second heat exchanger through the (2-1)-th fluid circulation line to exchange heat with the first fluid so as to be cooled and then being introduced into the second hydrogen storage part through the (2-4)-th fluid circulation line to cool the second hydrogen storage part.

The two-side heat exchange mode may further include a (2-4)-th fluid circulation operation of the second fluid being introduced into the thermal device through the (2-3)-th fluid circulation line to be heated and then being introduced into the first hydrogen storage part through the (2-2)-th fluid circulation line to heat the first hydrogen storage part.

The (2-1)-th fluid circulation operation and the (2-2)-th fluid circulation operation may be performed in a time-sequentially overlapping state, the (2-3)-th fluid circulation operation and the (2-4)-th fluid circulation operation may be performed in a time-sequentially overlapping state, and the (2-3)-th fluid circulation operation and the (2-4)-th fluid circulation operation may be performed after the (2-1)-th fluid circulation operation and the (2-2)-th fluid circulation operation.

The second fluid circulation line may include a (2-1)-th fluid circulation line connecting the second heat exchanger and the second flow rate control member and having a closed loop shape, a (2-2)-th fluid circulation line connecting the first hydrogen storage part and the second flow rate control member and having a closed loop shape, a (2-3)-th fluid circulation line connecting one side and an opposite side of the second flow rate control member and having a closed loop shape, and a (2-4)-th fluid circulation line connecting the second hydrogen storage part and the second flow rate control member and having a closed loop shape, and the thermal device may be provided on the (2-3)-th fluid circulation line, and the two-side heat exchange mode may further include a (1-1)-th fluid circulation operation of the first fluid sequentially circulating in the first heat exchanger, the compressor, the second heat exchanger, and the expansion member through the first fluid circulation line, and a (2-5)-th circulation operation of the second fluid being introduced into the second heat exchanger through the (2-1)-th fluid circulation line to exchange heat with the first fluid to be heated and then being introduced into the first hydrogen storage part or the second hydrogen storage part through the (2-2)-th fluid circulation line or the (2-4)-th fluid circulation line to heat the first hydrogen storage part or the second hydrogen storage part.

The two-side heat exchange mode may further include a (2-6)-th circulation operation of the second fluid being heated in the thermal device through the (2-3)-th fluid circulation line and then being introduced into the first hydrogen storage part or the second hydrogen storage part through the (2-2)-th fluid circulation line or the (2-4)-th fluid circulation line to heat the first hydrogen storage part or the second hydrogen storage part.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a closed loop shape. The thermal device may be provided on the (2-3)-th fluid circulation line. The one-side heat exchange mode may further include a (1-1)-th fluid circulation operation of the first fluid sequentially circulating in the first heat exchanger, the compressor, the second heat exchanger, and the expansion member through the first fluid circulation line, and a (2-7)-th circulation operation of the second fluid being introduced into the second heat exchanger through the (2-1)-th fluid circulation line to exchange heat with the first fluid to be heated and then being introduced into the first hydrogen storage part and the second hydrogen storage part through the (2-2)-th fluid circulation line and the (2-4)-th fluid circulation line to heat the first hydrogen storage part and the second hydrogen storage part, and in the (2-7)-th fluid circulation operation, flows of the second fluid may be substantially stopped in the (2-3)-th fluid circulation line.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a closed loop shape. The thermal device may be provided on the (2-3)-th fluid circulation line. The one-side heat exchange mode may include a (2-8)-th circulation operation of the second fluid being heated in the thermal device through the (2-3)-th fluid circulation line and then being introduced into the first hydrogen storage part and the second hydrogen storage part through the (2-2)-th fluid circulation line and the (2-4)-th fluid circulation line to heat the first hydrogen storage part and the second hydrogen storage part, and in the (2-8)-th fluid circulation operation, the flows of the first fluid in the first fluid circulation line and the second fluid in the (2-1)-th fluid circulation line may be substantially stopped.

The second fluid circulation line may include a (2-1)-th fluid circulation line connecting the second heat exchanger and the second flow rate control member and having a closed loop shape. The second fluid circulation line may also include a (2-2)-th fluid circulation line connecting the first hydrogen storage part and the second flow rate control member and having a closed loop shape. The second fluid circulation line may further include a (2-3)-th fluid circulation line connecting one side and an opposite side of the second flow rate control member and having a closed loop shape. The second fluid circulation line may additionally include a (2-4)-th fluid circulation line connecting the second hydrogen storage part and the second flow rate control member and having a closed loop shape. The thermal device may be provided on the (2-3)-th fluid circulation line. The one-side heat exchange mode may include a (1-2)-th fluid circulation operation of the first fluid sequentially circulating in the first heat exchanger, the expansion member, the second heat exchanger, and the compressor through the first fluid circulation line, and a (2-9)-th circulation operation of the second fluid being introduced into the second heat exchanger through the (2-1)-th fluid circulation line to exchange heat with the first fluid to be cooled and then being introduced into the first hydrogen storage part and the second hydrogen storage part through the (2-2)-th fluid circulation line and the (2-4)-th fluid circulation line to cool the first hydrogen storage part and the second hydrogen storage part, and in the (2-9)-th fluid circulation operation, flows of the second fluid may be substantially stopped in the (2-3)-th fluid circulation line.

### BRIEF DESCRIPTION OF THE DRAWINGS

The above and other objects, features and advantages of the present disclosure should become more apparent from the following detailed description taken in conjunction with the accompanying drawings, in which:

FIG. 1 is a view illustrating a hydrogen supply module according to embodiments of the present disclosure;

FIG. 2 is a view illustrating a circulation path of a fluid when one of a first hydrogen storage part and a second hydrogen storage part is heated and the other is cooled in a two-side heat exchange mode of a hydrogen supply method according to a first embodiment of the present disclosure;

FIG. 3 is a view illustrating a circulation path of a fluid when a first hydrogen storage part and a second hydrogen storage part are heated in a one-side heat exchange mode of a hydrogen supply method according to the first embodiment of the present disclosure;

FIG. 4 is a view illustrating a circulation path of a fluid when a first hydrogen storage part and a second hydrogen storage part are cooled in a two-side heat exchange mode of a hydrogen supply method according to the first embodiment of the present disclosure;

FIG. 5 is a view illustrating a circulation path of a fluid when one of a first hydrogen storage part and a second hydrogen storage part is heated and the other is cooled in a two-side heat exchange mode of a hydrogen supply method according to a second embodiment of the present disclosure;

FIG. 6 is a view illustrating a circulation path of a fluid when a first hydrogen storage part and a second hydrogen storage part are heated in a two-side heat exchange mode of a hydrogen supply method according to the second embodiment of the present disclosure;

FIG. 7 is a view illustrating a circulation path of a fluid when a first hydrogen storage part and a second hydrogen storage part are cooled in a one-side heat exchange mode of a hydrogen supply method according to the second embodiment of the present disclosure;

FIG. 8 is a flowchart time-sequentially illustrating a process of performing a hydrogen adsorbing operation, a hydrogen storage part heating operation, a hydrogen desorbing operation, and a hydrogen storage part cooling operation, according to an embodiment of the present disclosure; and

FIG. 9 is a view illustrating an example of time-sequentially listing sequences of performing a hydrogen adsorbing operation, a hydrogen storage part heating operation, a hydrogen desorbing operation, and a hydrogen storage part cooling operation in a first hydrogen storage part and a second hydrogen storage part in a hydrogen supply method, according to an embodiment of the present disclosure.

### DETAILED DESCRIPTION

A hydrogen supply module and a hydrogen supply method according to embodiments of the present disclosure may be used to replace a hydrogen storage system according to a conventional technology, which compresses hydrogen in a gaseous state by using a compressor that is driven by electric energy, stores it, and supplies hydrogen to a source of demand that requires hydrogen.

According to embodiments of the present disclosure, hydrogen may be adsorbed in a metal or an alloy that may adsorb or desorb hydrogen by using properties of the metal or the alloy. The hydrogen may be stored in a form of a hydride. The hydrogen may be desorbed from the hydride and may be supplied to a source of demand for the hydrogen. The desorption of the hydrogen that occurs in the hydride may occur according to a change in a temperature and a temperature of the hydride. The absorption of the hydrogen that occurs in the metal or the alloy may occur according to a change in a temperature and a pressure of the metal or the alloy. The hydrogen supply module and the hydrogen supply method according to embodiments of the present disclosure may be closely related to a thermal energy transferring method for occurrence of the desorption of the hydrogen and the adsorption of the hydrogen. For example, because the process of the hydrogen being adsorbed in the metal or the alloy is an exothermic process, it is desired to retrieve thermal energy generated in the process of adsorbing the hydrogen and discharge the thermal energy to an outside to smoothly adsorb the hydrogen in the metal or the alloy. Further, because the process of desorbing the hydrogen from the hydride is an endothermic process, it is desired to supply the thermal energy required for the process of desorbing the hydrogen to the hydride to smoothly desorb the hydrogen from the hydride. The hydrogen supply module and the hydrogen supply method according to embodiments of the present disclosure may adjust a temperature and a pressure of the hydride, the metal, or the alloy by causing the thermal energy that is desired in the above-described process of adsorbing and desorbing the hydrogen to flow smoothly.

Hereinafter, the hydrogen supply module and the hydrogen supply method according to embodiments of the present disclosure are described with reference to the accompanying drawings.

In the description herein, when a part, component, device, element, or the like of the present disclosure is described as having a purpose or performing an operation, function, or the like, the part, component, device, or element should be considered herein as being “configured to” meet that purpose or perform that operation or function.

Hydrogen Supply Module

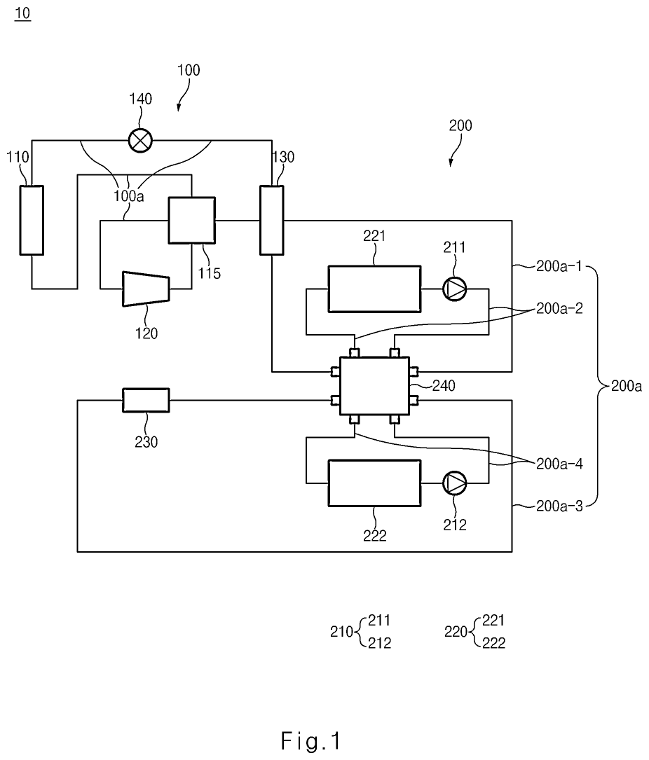

FIG. 1 is a view illustrating a hydrogen supply module according to an embodiment of the present disclosure.

Referring to FIG. 1, a hydrogen supply module according to an embodiment of the present disclosure may include a first fluid circulation part 100 and second fluid circulation part 200. The first fluid circulation part 100 may include a first circulation line 100a in which a first fluid circulates. The second fluid circulation part 200 may include a second fluid circulation line 200a in which a second fluid circulates. As described in more detail below, the first fluid that circulates in the first fluid circulation part 100 may exchange heat with an outside, the second fluid that circulates in the second fluid circulation part 200 may exchange heat with the above-described first fluid, and the second fluid may exchange heat with the hydrogen storage part that is described below. As an example, the first fluid may be a refrigerant that is used in a refrigeration cycle, and the second fluid may be cooling water. However, types of the first fluid and the second fluid are not limited by the above-described contents.

The first fluid circulation part 100 may include a first heat exchanger 110 in which the first fluid and an external fluid exchange heat. The first heat exchanger 110 may be a component configured for exchanging heat with the outside to heat or cool the first fluid. For example, the first heat exchanger 110 may be an evaporator or a condenser.

According to embodiment of the present disclosure, the first fluid circulation part 100 may further include a first flow rate control member 115 that is connected to the first heat exchanger 110 through the first fluid circulation line 100a to control flows of the first fluid. The first flow rate control member 115 may be a valve member that may control flow directions of the fluid. For example, the first flow rate control member 115 may be a 4-way valve. As described in more detail below, according to embodiments of the present disclosure, the flow direction of the first fluid that circulates in the first fluid circulation line 100a may be changed. The first flow rate control member 115 may be a component configured for changing the flow direction of the first fluid that flows on the first fluid circulation line 100a by controlling the flow direction of the first fluid. The first fluid circulation part 100 may further include a compressor 120 that is connected to the flow rate control member 115 through the first fluid circulation line 100a to compress the first fluid. For example, the compressor 120 may be a part or component configured for increasing a pressure and a temperature of the first fluid by compressing the first fluid that flows in a gaseous state. The first flow rate control member 115 may be a part or component configured for controlling the flow direction of the first fluid that is received from the compressor 120. For example, as illustrated in FIG. 1, a first side and a second side of the first flow rate control member 115 may be connected to the compressor 120 through the first fluid circulation line 100a The first fluid that is discharged from the first side of the first flow rate control member 115 and is introduced into the compressor 120 may thus be introduced into the second side of the first flow rate control member 115 after being compressed. It is noted that, as used herein, two parts or components being connected to each other through the first fluid circulation line 110a or the second fluid circulation line 200a does not necessarily mean that the two parts or components are directly connected to each other through the first fluid circulation line 100a or the second fluid circulation line 200a, but may also mean that the two parts or components are indirectly connected to each other by providing another part or component between the two parts or components in the first fluid circulation line 100a or the second fluid circulation line 200a. For illustrative purposes, FIG. 1 illustrates as an example in which the first heat exchanger 110 and the first flow rate control member 115 are directly connected to each other and the first flow rate control member 115 and the compressor 120 are directly connected to each other through the first fluid circulation line 100a.

The first fluid circulation part 100 may further include a second heat exchanger 130 that is connected to the compressor 120 through the first fluid circulation line 100a and an expansion member 140 that is connected to the second heat exchanger 130 through the first fluid circulation line 110 to expand the first fluid. The expansion member 140 may be an expansion valve, for example. Merely for illustrative purposes, FIG. 1 illustrates as an example in which the first flow rate control member 115 and the second heat exchanger 130 are directly connected to each other and the second heat exchanger 130 and the expansion member 140 are directly connected to each other through the first fluid circulation line 110a.

The first fluid circulation line 100a may have a closed loop shape in which the first heat exchanger 110, the compressor 120, the second heat exchanger 130, and the expansion member 140 are sequentially connected to each other. Accordingly, the first fluid that flows in the first fluid circulation line 100a may repeatedly circulate while passing through the first heat exchanger 110, the compressor 120, the second heat exchanger 130, and the expansion member 140. Accordingly, as described above, according to embodiments of the present disclosure, a plurality of flow directions of the first fluid may be formed through control of the first flow rate control member 115.

The second heat exchanger 130 may be a part or component configured for exchanging heat between the first fluid and the second fluid. To achieve the above-described object, the second fluid circulation line 200a may be provided to be connected to the second heat exchanger 130, and the first fluid and the second fluid may be provided to exchange heat in the second heat exchanger 130. As described above, according to the present disclosure, the first fluid and the second fluid may exchange heat in the second heat exchanger 130 such that the first fluid is cooled while the second fluid is heated. Also, the first fluid and the second fluid may exchange heat in the second heat exchanger 130 such that the first fluid is heated while the second fluid is cooled.

The second fluid circulation part 200 may further include a pump 210 that is connected to the second heat exchanger 130 through the second fluid circulation line 200a to pump the second fluid that is in a liquid state. The second fluid circulation part 200 may also include a hydrogen storage part 220 that is connected to the second heat exchanger 130 through the second fluid circulation line 200a. According to embodiments of the present disclosure, the second fluid that is pumped by the pump 210 may be supplied to the second heat exchanger 130, may exchange heat with the first fluid, and may be supplied to the hydrogen storage part 220. Furthermore, similar to the first fluid circulation line 100a, the second fluid circulation line 200a may have a closed loop shape, in which the second heat exchanger 130, the hydrogen storage part 220, and the pump 210 are sequentially connected to each other. Accordingly, the second fluid that flows in the second fluid circulation line 200a may repeatedly circulate while passing through the second heat exchanger 130, the hydrogen storage part 220, and the pump 210.

According to embodiments of the present disclosure, the hydrogen storage part 220 may be a part or component configured to store and discharging hydrogen according to temperature. In an embodiment, the hydrogen storage part 220 may include a metal or an alloy that may adsorb the hydrogen. The metal or the alloy provided in the hydrogen storage part 220 according to an embodiment the present disclosure may be a material to which the hydrogen may be coupled. The hydrogen may be adsorbed to form a hydride according to temperature. The hydrogen may be desorbed from the hydride to be converted into a metal or alloy state again.

In more detail, the process of the hydrogen being adsorbed in the metal or the alloy may be an exothermic process, and the process of the hydrogen being desorbed from the hydride may be an endothermic process. Accordingly, it is necessary to retrieve thermal energy from the metal or the alloy to adsorb the hydrogen to the metal or the alloy, and it is necessary to supply the thermal energy to the hydride to desorb the hydrogen from the hydride. According to embodiments of the present disclosure, thermal energy may be retrieved from the metal or the alloy through the second fluid that is supplied to the hydrogen storage part 220 provided with the metal or the alloy or the thermal energy may be supplied to the hydride. Accordingly, the adsorption and the desorption of the hydrogen may be controlled.

According to embodiments of the present disclosure, a function of storing hydrogen by the hydrogen storage part 220 when the hydrogen is adsorbed in the metal or the alloy may be performed and a function of supplying the hydrogen to the outside by the hydrogen storage part 220 when the hydrogen is desorbed from the hydride may be performed. Accordingly, a hydrogen storage system according to a conventional technology, in which hydrogen is stored in a container by using a compressor and the hydrogen is supplied to the outside, may be replaced.

The hydride that is formed when the metal or the alloy that may form the above-described hydride is adsorbed may include Mg, Li, LiAl, NaB, NaAl, TiFe, LaNi₅, TiMn₂, VH₂, and TiCr₂, for example. However, the type of the metal or the alloy that may be included in the hydrogen storage part 220 is not limited to the above-described contents.

According to embodiments of the present disclosure, the second fluid may circulate in one direction in the second fluid circulation part 200. For example, referring to FIG. 1, the second fluid circulation part 200 may be configured such that the second fluid sequentially passes through the second heat exchanger 130, the hydrogen storage part 220, and the pump 210 through the second circulation line 200a. In this example, the second fluid that passed through the pump 210 may be supplied to the second heat exchanger 130 again.

According to embodiments of the present disclosure, the second fluid may circulate in two directions in the first fluid circulation part 100. For example, as illustrated in FIG. 1, the first side of the first flow rate control member 115 and the second side spaced apart from the first side may be connected to the compressor 120 through the first fluid circulation line 100a. The first fluid circulation part 100 may be configured such that the first fluid i) sequentially passes through the first flow rate control member 115, the compressor 120, the first flow rate control member 115, and the second heat exchanger 130 or ii) sequentially passes through the first flow rate control member 115, the compressor 120, the first flow rate control member 115, and the first heat exchanger 110. As described in more detail below, according to embodiments of the present disclosure, the second fluid may be heated by the first fluid when the first fluid flows along the above-described path i), and the second fluid may be cooled by the first fluid when the first fluid flows along the above-described path ii).

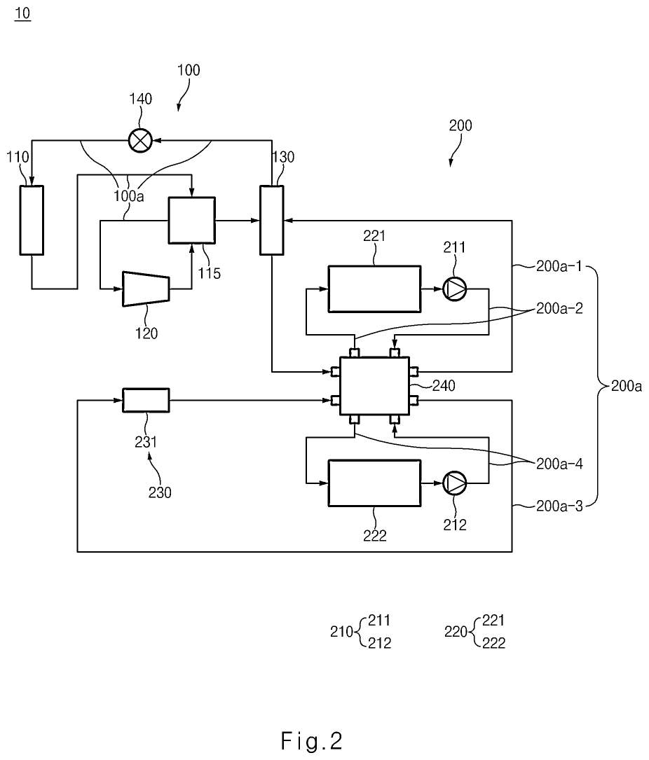

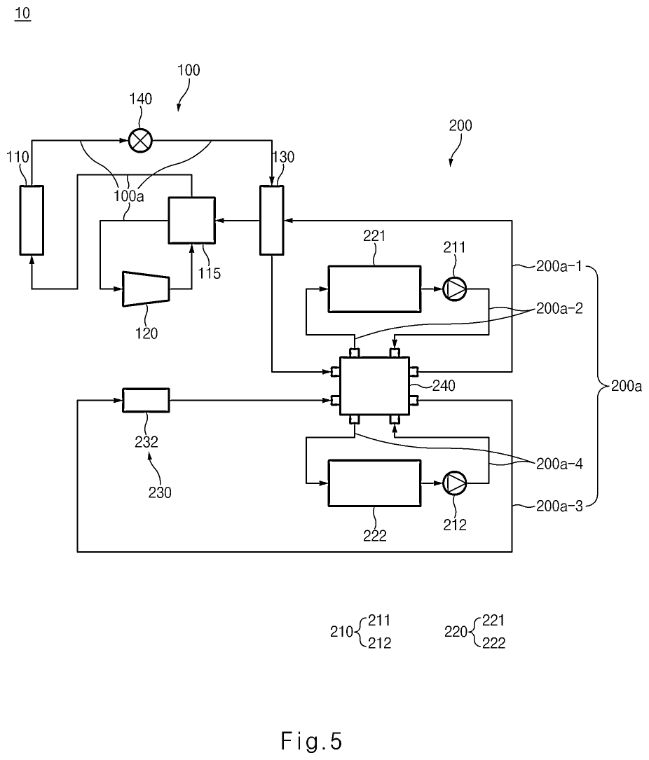

Referring still to FIG. 1, the hydrogen supply module 10 may further include a thermal device 230. The thermal device 230 may be a part or components that is provided on the second fluid circulation line 200a to heat or cool the second fluid. For example, as illustrated in FIG. 1, the thermal device 230 may be provided on an upstream area of the hydrogen storage part 220 in the second fluid circulation line 200a to heat or cool the second fluid before the second fluid is supplied to the hydrogen storage part 220. In an aspect in which the thermal device 230 is provided on an upstream side of the hydrogen storage part 220, the second fluid may be supplied to the hydrogen storage part 220 while passing through the thermal device 230. In an aspect in which the thermal device 230 is a part or component configured for heating the second fluid, the thermal device 230 may be a heating member 232 (see e.g., FIG. 5), such as an electric heater, a gas heater, a thermoelectric element, or the like. In an aspect in which the thermal device 230 is a part or component configured for cooling the second fluid, the thermal device 230 may be a heat dissipating member 231 (see e.g., FIG. 2), such as a radiator or the like.

The hydrogen supply module 10 may further include a second flow rate control member 240 that is provided on the second fluid circulation line 200a to control the flow of the second fluid that flows on the second fluid circulation line 200a. As described in more detail below, the second flow rate control member 230 may be connected to the second fluid circulation line 200a in a plurality of areas. The second flow rate control member 240 may adjust the flow direction of the second fluid that flows in the second fluid circulation line 200a according to time. As an example, the second flow rate control member 240 may include a plurality of valves that are controlled electronically.

According to embodiments of the present disclosure, a plurality of hydrogen storage parts may be provided in the hydrogen supply module 10. For example, the hydrogen storage part 220 may include a first hydrogen storage part 221 that is provided on the second fluid circulation line 200a and a second hydrogen storage part 222 that is provided on the second fluid circulation line 200a. The second hydrogen storage part 222 may be connected to the first hydrogen storage part 221 through the second fluid circulation line 200a. The second flow rate control member 240 may be interposed therebetween. The first hydrogen storage part 221 and the second hydrogen storage part 222 may thus be disposed on the second fluid circulation line 200a in parallel. According to embodiments of the present disclosure, the second fluid heated or cooled in the second heat exchanger 130 and the second fluid heated or cooled in the thermal device 230 may be supplied to the first hydrogen storage part 221 or the second hydrogen storage part 222 according to a control of the second flow rate control member 240. Thus, the first hydrogen storage part 221 and the second hydrogen storage part 222 may be heated or cooled.

Furthermore, the second fluid circulation line 200a provided in the hydrogen supply module 10 may include a plurality of areas. For example, as illustrated in FIG. 1, the second fluid circulation line 200a may include a (2-1)-th fluid circulation line 200a-1 that connects the second heat exchanger 130 and the second flow rate control member 240 and has a closed loop shape. The second fluid circulation line 200a may also include a (2-2)-th fluid circulation line 200a-2 that connects the first hydrogen storage part 221 and the second flow rate control member 240 and has a closed loop shape. The second fluid circulation line 200a may further include a (2-3)-th fluid circulation line 200a-3 that connects one end and an opposite end of the second flow rate control member 230 and has a closed loop shape. The second fluid circulation line 200a may additionally include a (2-4)-th fluid circulation line 200a-4 that connects the second hydrogen storage part 222 and the second flow rate control member 240 and has a closed loop shape. The thermal device 230 may be provided on the (2-3)-th fluid circulation line 200a-3. The (2-1)-th fluid circulation line 200a-1, the (2-2)-th fluid circulation line 200a-2, the (2-3)-th fluid circulation line 200a-3, and the (2-4)-th fluid circulation line 200a-4 may thus be disposed in parallel to each other.

It is noted that that the fluid circulation line 200a is generally described herein as being divided into the (2-1)-th to (2-4)-th fluid circulation lines 200a-1, 200a-2, 200a-3, and 200a-4, this does not mean that the second fluid is provided only in isolated states such that the second fluid cannot flow between the (2-1)-th to (2-4)-th fluid circulation lines 200a-1, 200a-2, 200a-3, and 200a-4. Rather, according to embodiments of the present disclosure, the second fluid may flow between the (2-1)_th to (2-4)-th fluid circulation lines 200a-1, 200a-2, 200a-3, and 200a-4. Thus, the second flow rate control member 240 may control the flow directions of the second fluid in the (2-1)-th fluid circulation line 200a-1, the (2-2)-th fluid circulation line 200a-2, the (2-3)-th fluid circulation line 200a-3, and the (2-4)-th fluid circulation line 200a-4.

In an aspect in which the hydrogen storage part 220 includes the first hydrogen storage part 221 provided on the (2-2)-th fluid circulation line 200a-2 and the second hydrogen storage part 222 provided on the (2-4)-th fluid circulation line 200a-4, the pump 210 may include a first pump 211 provided on the (2-2)-th fluid circulation line 200a-2 and a second pump 212 provided on the (2-4)-th fluid circulation line 200a-4. As an example, the first pump 211 and the second pump 212 may be provided in a downstream area of the first hydrogen storage part 221 and a downstream area of the second hydrogen storage part 220 with reference to the flow direction of the second fluid, respectively.

The hydrogen supply module 10 according to embodiments of the present disclosure may further include a gas/liquid separator that separates a gas by removing a liquid component from the first fluid. The gas/liquid separator may be provided in an area in which the first fluid is supplied from the first fluid circulation line 100a to the compressor 120. The gas/liquid separator may be a part or component configured for minimizing damage to the compressor 120 by supplying only the first fluid in the gaseous state.

The hydrogen supply module 10 according to embodiments of the present disclosure may further include a receiver-dryer that separates the gas component from the liquid by removing the gaseous component from the first fluid. The receiver-dryer may be provided in an area of the first fluid circulation line 100a between the second heat exchanger 130 and the expansion member 140. The receiver-dryer may thus supply only the first fluid in the liquid state to the expansion member 140. However, according to the performances of the first heat exchanger 110 and the second heat exchanger 130, only the first fluid in the liquid state may be supplied to the expansion member 140 with no receiver-driver, and in this case, the receiver-driver may be omitted.

The hydrogen supply module 10 according to the present disclosure may further include a reservoir that separates the gaseous component from the liquid by collecting the gaseous components from the second fluid. In more detail, the reservoir may be a configuration for causing the second fluid to circulate on the second fluid circulation line 200a only in the liquid state. That is, the reservoir may be provided on the second fluid circulation line 200a, and when the second fluid that floes in the second fluid circulation line 200a is introduced into the reservoir, the gases component in the second fluid flows upward in the reservoir due to a difference from the density of the liquid component in the second fluid. The reservoir may cause only the liquid component in the second fluid to flow in the second fluid circulation line 200a by collecting the gaseous component of the second fluid that flowed upwards. The reservoir may be provided at various locations on the second fluid circulation line 200a, and as an example, the reservoir may be provided at an uppermost end area of the second fluid circulation line 200a to effectively collect the gaseous component in the second fluid.

Hydrogen Supply Method

Hereinafter, a hydrogen supply method according to embodiments of the present disclosure is described with reference to the accompanying drawings and the above-described contents.

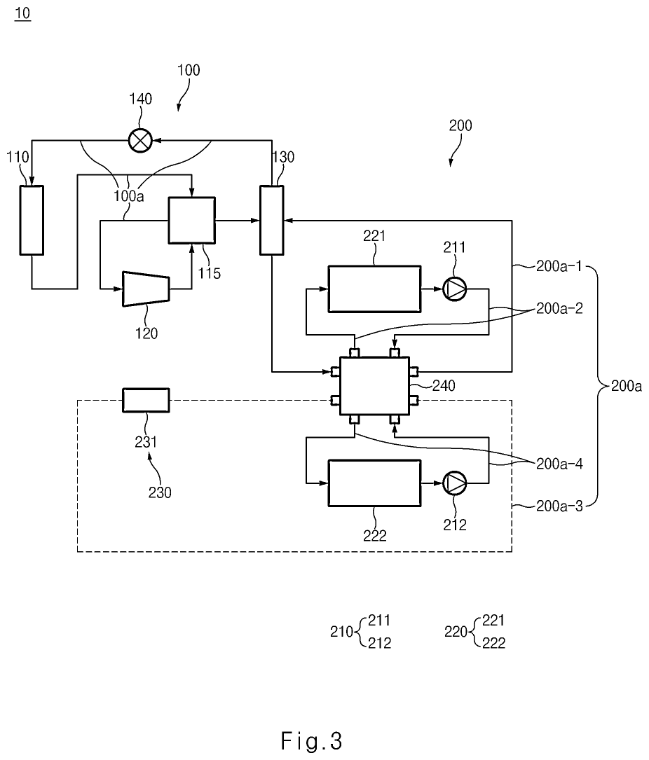

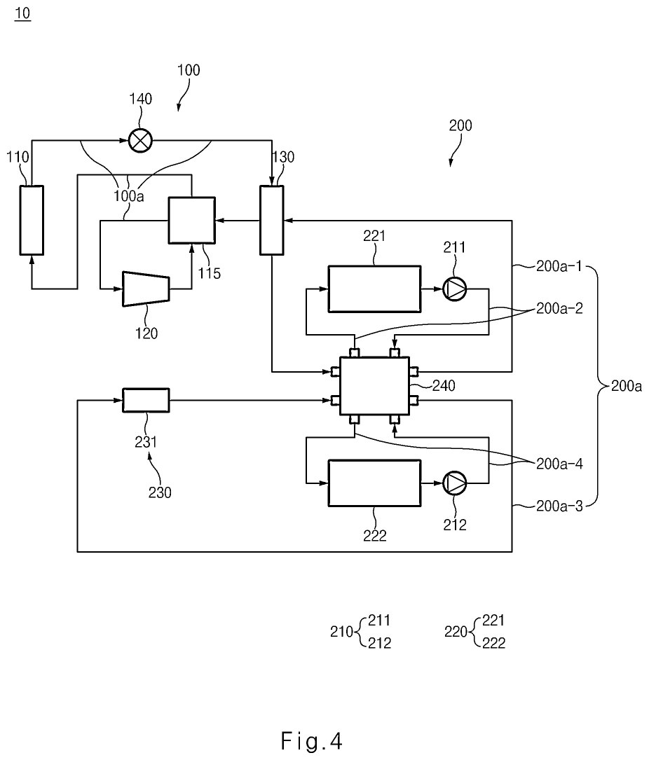

FIG. 2 is a view illustrating a circulation path of a fluid when one of the first hydrogen storage part and the second hydrogen storage part is heated and the other is cooled in a two-side heat exchange mode of a hydrogen supply method according to a first embodiment of the present disclosure. FIG. 3 is a view illustrating a circulation path of a fluid when the first hydrogen storage part and the second hydrogen storage part are heated in a one-side heat exchange mode of the hydrogen supply method according to the first embodiment of the present disclosure. FIG. 4 is a view illustrating a circulation path of a fluid when the first hydrogen storage part and the second hydrogen storage part are cooled in the two-side heat exchange mode of the hydrogen supply method according to the first embodiment of the present disclosure.

The hydrogen supply method according to embodiments of the present disclosure may be performed using the hydrogen supply module 10, for example.

In embodiment, the second fluid circulation part 200 of the hydrogen supply method 10 may include a thermal device 230 that is provided on the second fluid circulation line 200a. The hydrogen supply method according to embodiments of the present disclosure may include a two-side heat exchange mode and a one-side heat exchange mode. In the two-side heat exchange mode, both of i) introducing the second fluid into the hydrogen storage part 220 after the second fluid exchanges heat with the first fluid in the second heat exchanger 130 in a state in which the compressor 120 is driven to compress the first fluid and ii) introducing the second fluid into the hydrogen storage part 220 after the second fluid is heated or cooled in the thermal device 230 may be performed. In the one-side heat exchange mode, only one of i) introducing the second fluid into the hydrogen storage part 220 after the second fluid exchanges heat with the first fluid in the second heat exchanger 130 in a state, in which the compressor 120 is driven to compress the first fluid, and ii) introducing the second fluid into the hydrogen storage part 220 after the second fluid is heated or cooled in the thermal device 230 may be performed.

The two-side heat exchange mode and the one-side heat exchange mode may thus be different in that both of the second fluid that passes through the second heat exchanger 130 and the second fluid that passes through the thermal device 230 are supplied to the hydrogen storage part 220 in the two-side heat exchange mode, whereas the second fluid is supplied to the hydrogen storage part 220 after exchanging heat while passing through only one of the second heat exchanger 130 and the thermal device 230 in the one-side heat exchange mode.

According to embodiments of the present disclosure, the two-side heat exchange mode and the one-side heat exchange mode=described above may be time-sequentially performed in separate time periods. Accordingly, the two-side heat exchange mode and the one-side heat exchange mode may be performed in an alternating fashion.

As described in more detail below, in the hydrogen supply method according to embodiments of the present disclosure, a process of adsorbing and desorbing the hydrogen may be repeatedly performed in the first hydrogen storage part 221 and the second hydrogen storage part 222. Accordingly, the first hydrogen storage part 221 and the second hydrogen storage part 222 repeatedly perform the heating and cooling processes. The first hydrogen storage part 221 and the second hydrogen storage part 222 may supply the hydrogen to an external source of demand in the process of desorbing the hydrogen. To consistently supply the hydrogen to the external source of demand, a preliminary operation for desorbing the hydrogen needs to be performed in the second hydrogen storage part 222 while the hydrogen is desorbed in the first hydrogen storage part 221 Also, the first hydrogen storage part 221 needs to perform a preliminary operation for desorbing the hydrogen while the hydrogen is desorbed in the second hydrogen storage part 222. To achieve the above-described object, a graph of a temperature of the second fluid supplied to the first hydrogen storage part 221 according to time and a graph of the second fluid supplied to the second hydrogen storage part 222 according to time need to have a relationship of being horizontally spaced apart from each other by a specific time period. Accordingly, according to embodiments of the present disclosure, the two-side heat exchange mode and the one-side heat exchange mode are alternately performed according to time whereby a temperature of the second fluid supplied to the first hydrogen storage part 221 and a temperature of the second fluid supplied to the second hydrogen storage part 222 may be controlled individually. Hereinafter, a means for individually controlling the temperature of the second fluid supplied to the first hydrogen storage part 221 and the temperature of the second fluid supplied to the second hydrogen storage part 222, according to an embodiment of the present disclosure, is described.

As described above, the second fluid circulation line 200a may include a (2-1)-th fluid 200a-1 circulation line that connects the second heat exchanger 130 and the second flow rate control member 240 and has a closed loop shape. The second fluid circulation line 200a may also include a (2-2)-th fluid circulation line 200a-2 that connects the first hydrogen storage part 221 and the second flow rate control member 240 and has a closed loop shape. The second fluid circulation line 200a may further include a (2-3)-th fluid circulation line that connects one end and an opposite end of the second flow rate control member 230, has a closed loop shape, and is provided with the thermal device 230. The second fluid circulation line 200a may additionally include a (2-4)-th fluid circulation line 200a-4 that connects the second hydrogen storage part 222 and the second flow rate control member 240 and has a closed loop shape. Furthermore, the thermal device 230 may be provided on the (2-3)-th fluid circulation line 200a-3.

As illustrated in FIG. 2, according to a first embodiment of the present disclosure, the two-side heat exchange mode may include a (1-1)-th fluid circulation operation of the first fluid sequentially circulating in the first heat exchanger 110, the compressor 120, the second heat exchanger 130, and the expansion member 140 through the first fluid circulation line 100a. The two-side heat exchange mode according to the first embodiment of the present disclosure may also include a (2-1)-th fluid circulation operation of the second fluid being introduced into the second heat exchanger 130 through the (2-1)-th fluid circulation line 200a-1 to exchange heat with the first fluid so as to be heated and then being introduced into the first hydrogen storage part 221 through the (2-2)-th fluid circulation line 200a to heat the first hydrogen storage part 221. Furthermore, the two-side heat exchange mode according to the first embodiment of the present disclosure may further include a (2-2)-th fluid circulation operation of the second fluid being introduced into the thermal device 230 through the (2-3)-th fluid circulation line 200a-3 to be cooled and then being introduced into the second hydrogen storage part 222 through the (2-4)-th fluid circulation line 200a-4 to cool the second hydrogen storage part 222. Thus, according to the first embodiment of the present disclosure, the thermal device 230 may be a heat dissipating member 231. Accordingly, in the (2-1)-th fluid circulation operation of the first embodiment of the present disclosure, the first hydrogen storage part 221, or the metal or the alloy in the first hydrogen storage part 221, may be heated by the second fluid. Also, in the (2-2)-th fluid circulation operation of the first embodiment of the present disclosure, the second hydrogen storage part 222 or the metal or the alloy in the second hydrogen storage part 222 may be cooled by the second fluid.

The (2-1)-th fluid circulation operation and the (2-2)-th fluid circulation operation may be performed in a time-sequentially overlapping manner. For example, the (2-1)-th fluid circulation operation and the (2-2)-th fluid circulation operation may be performed at the same time. Accordingly, because the first hydrogen storage part 221 is heated while the (2-1)-th fluid circulation operation and the (2-2)-th fluid circulation operation are performed together, the first hydrogen storage part 221 may perform an hydrogen storage part heating operation and a hydrogen desorbing operation, described below. Further, because the second hydrogen storage part 222 is cooled at the same time, the second hydrogen storage part 222 may perform a hydrogen storage part cooling operation and a hydrogen adsorbing operation described below.

Referring still to FIG. 2, the two-side heat exchange mode may further include a (2-3)-th fluid circulation operation of the second fluid being introduced into the second heat exchanger 130 through the (2-1)-th fluid circulation line 200a-1 to exchange heat with the first fluid so as to be heated and then being introduced into the second hydrogen storage part 222 through the (2-4)-th fluid circulation line 200a-4 to heat the second hydrogen storage part 222. The two-side heat exchange mode may additionally include a (2-4)-th fluid circulation operation of the second fluid being introduced into the thermal device 230, or more specifically into the heat dissipating member 231, through the (2-3)-th fluid circulation line 200a-3 to be cooled and then being introduced into the first hydrogen storage part 221 through the (2-2)-th fluid circulation line 200a-2 to cool the first hydrogen storage part 221.

In an embodiment, the (2-3)-th fluid circulation operation and the (2-4)-th fluid circulation operation may be performed in a time-sequentially overlapping state. For example, the (2-3)-th fluid circulation operation and the (2-4)-th fluid circulation operation may be performed at the same time. Accordingly, because the first hydrogen storage part 221 is cooled while the (2-3)-th fluid circulation operation and the (2-4)-th fluid circulation operation are performed together, the first hydrogen storage part 221 may perform an hydrogen storage part cooling operation and a hydrogen adsorbing operation described below. Further, because the second hydrogen storage part 222 is heated at the same time, the second hydrogen storage part 222 may perform a hydrogen storage part heating operation and a hydrogen desorbing operation described below.

In the first embodiment of the present disclosure, the (2-3)-th fluid circulation operation and the (2-4)-th fluid circulation operation may be performed after the (2-1)-th fluid circulation operation and the (2-2)-th fluid circulation operation. Accordingly, according to embodiments of the present disclosure, a process of cooling the second hydrogen storage part 222 while the first hydrogen storage part 221 and a process of heating the second hydrogen storage part 222 while the first hydrogen storage part 221 is cooled may be repeatedly performed. Thus, the hydrogen may be consistently supplied to an external source of demand.

In the hydrogen supply method according to embodiments of the present disclosure, to smoothly adsorb and desorb the hydrogen in the first hydrogen storage part 221 and the second hydrogen storage part 222 in the process of the second fluid being introduced into the first hydrogen storage part 221 and the process of the second fluid being introduced into the second hydrogen storage part 222, a time period that is desired for time-sequentially heating both of the first hydrogen storage part 221 and the second hydrogen storage part 222. However, in the (2-1)-th fluid circulation operation, the (2-2)-th fluid circulation operation, the (2-3)-th fluid circulation operation, and the (2-4)-th fluid circulation operation, as described above, when one of the first hydrogen storage part 221 and the second hydrogen storage part 222 is heated, the other one of the first hydrogen storage part 221 and the second hydrogen storage part 222 is cooled.

Accordingly, the one-side heat exchange mode in the hydrogen supply method according to embodiments of the present disclosure may include an operation for heating both of the first hydrogen storage part 221 and the second hydrogen storage part 222.

For example, as illustrated in FIG. 3, the one-side heat exchange mode in the hydrogen supply method according to the first embodiment of the present disclosure may further include a (1-1)-th fluid circulation operation of the first fluid sequentially circulating in the first heat exchanger 110, the compressor 120, the second heat exchanger 130, and the expansion member 140 through the first fluid circulation line 100a. The one-side heat exchange mode in the hydrogen supply method according to the first embodiment of the present disclosure may also include a (2-5)-th circulation operation of the second fluid being introduced into the second heat exchanger 130 through the (2-1)-th fluid circulation line 200a-1 to exchange heat with the first fluid to be heated and then being introduced into the first hydrogen storage part 221 and the second hydrogen storage part 222 through the (2-2)-th fluid circulation line 200a-2 and the (2-4)-th fluid circulation line 200a-4 to heat the first hydrogen storage part 221 and the second hydrogen storage part 222. Further, in the (2-5)-th fluid circulation operation, the flow of the second fluid may be substantially stopped in the (2-3)-th fluid circulation line 200a-3 and the driving of the thermal device 230 may be stopped. The cooling of the second fluid may thus not be substantially performed in the thermal device 230, or more specifically, in the heat dissipating member 231. Accordingly, according to the (2-5)-th fluid circulation operation of the first embodiment of the present disclosure, because only the second fluid heated in the second heat exchanger 130 is supplied to the first hydrogen storage part 221 and the second hydrogen storage part 222, the heating of the first hydrogen storage part 221 and the heating of the second hydrogen storage part 222 may be performed together.

In the hydrogen supply process, unlike in the process described above, a time period in which it is necessary to cool both of the first hydrogen storage part 221 and the second hydrogen storage part 222 may be present. For example, when a hydrogen adsorption efficiency and a hydrogen desorption efficiency for the metal or the alloy in the hydrogen storage part 220 are lowered in a process of consistently driving the hydrogen supply module 10, it may be necessary to cool both of the first hydrogen storage part 221 and the second hydrogen storage part 222 for a specific time period.

Accordingly, the two-side heat exchange mode described above in the hydrogen supply method according to embodiments of the present disclosure may further include an operation for cooling both of the first hydrogen storage part 221 and the second hydrogen storage part 222.

For example, as illustrated in FIG. 4, the two-side heat exchange mode in the hydrogen supply method according to the first embodiment of the present disclosure may include a (1-2)-th fluid circulation operation of the first fluid sequentially circulating in the first heat exchanger 110, the expansion member 140, the second heat exchanger 130, and the compressor 120 through the first fluid circulation line 200a-1. The two-side heat exchange mode in the hydrogen supply method according to the first embodiment of the present disclosure may further include a (2-6)-th circulation operation of the second fluid being introduced into the second heat exchanger 130 through the (2-1)-th fluid circulation line 200a-1 to exchange heat with the first fluid to be cooled and then being introduced into the first hydrogen storage part 221 or the second hydrogen storage part 222 through the (2-2)-th fluid circulation line 200a-2 or the (2-4)-th fluid circulation line 200a-4 to cool the first hydrogen storage part 221 or the second hydrogen storage part 222. The two-side heat exchange mode in the hydrogen supply method according to the first embodiment of the present disclosure may additionally include a (2-7)-th circulation operation of the second fluid being cooled in the thermal device 230, or more specifically in the heat dissipating member 231, through the (2-3)-th fluid circulation line 200a-3 and then being introduced into the first hydrogen storage part 221 or the second hydrogen storage part 222 through the (2-2)-th fluid circulation line 200a-2 or the (2-4)-th fluid circulation line 200a-4 to cool the first hydrogen storage part 221 or the second hydrogen storage part 222. Accordingly, according to the (1-2)-th fluid circulation operation, the (2-6)-th fluid circulation operation, and the (2-7)-th fluid circulation operation of the first embodiment of the present disclosure, the first hydrogen storage part 221 and the second hydrogen storage part 222 may be cooled by the second fluid cooled in the second heat exchanger 130 and the thermal device 230, respectively.

The cooling of the first hydrogen storage part 221 and the second hydrogen storage part 222, unlike in the process described above, may also be performed in the one-side heat exchange mode.

For example, according to the first embodiment of the present disclosure, the one-side heat exchange mode may include a (1-2)-th fluid circulation operation of the first fluid sequentially circulating in the first heat exchanger 110, the expansion member 140, the second heat exchanger 130, and the compressor 120 through the first fluid circulation line 100a. The one-side heat exchange mode may also include a (2-8)-th circulation operation of the second fluid being introduced into the second heat exchanger 130 through the (2-1)-th fluid circulation line 200a-1 to exchange heat with the first fluid to be cooled and then being introduced into the first hydrogen storage part 221 and the second hydrogen storage part 222 through the (2-2)-th fluid circulation line 200a-2 and the (2-4)-th fluid circulation line 200a-4 to cool the first hydrogen storage part 221 and the second hydrogen storage part 222. According to the first embodiment of the present disclosure, in the (2-8)-th fluid circulation operation, the flow of the second fluid may be substantially stopped in the (2-3)-th fluid circulation line 200a-3 and the driving of the thermal device 230 may be stopped. The cooling of the second fluid may thus not be substantially performed in the thermal device 230, in detail, in the heat dissipating member 231. Accordingly, in the (2-8)-th fluid circulation operation of the one-side heat exchange mode, the second fluid may be supplied to the first hydrogen storage part 221 and the second hydrogen storage part 222 after being cooled in the second heat exchanger 130, and thus, the cooling of the first hydrogen storage part 221 and the second hydrogen storage part 222 may be performed together.

Furthermore, according to the first embodiment of the present disclosure, the one-side heat exchange mode may include a (2-9)-th circulation operation of the second fluid being cooled in the thermal device 230 through the (2-3)-th fluid circulation line 200a-3 and then being introduced into the first hydrogen storage part 221 and the second hydrogen storage part 222 through the (2-2)-th fluid circulation line 200a-2 and the (2-4)-th fluid circulation line 200a-4 to cool the first hydrogen storage part 221 and the second hydrogen storage part 222. In the (2-9)-th fluid circulation operation, the flow of the first fluid in the first fluid circulation line 100a and the flow of the second fluid in the (2-1)-th fluid circulation line 200a-1 may be substantially stopped. The cooling of the second fluid in the second heat exchanger 130 may thus not be substantially performed as the driving of the compressor 120 is stopped. Accordingly, in the (2-9)-th fluid circulation operation of the one-side heat exchange mode, the second fluid may be supplied to the first hydrogen storage part 221 and the second hydrogen storage part 222 after being cooled in the thermal device 230. Thus, the cooling of the first hydrogen storage part 221 and the second hydrogen storage part 222 may be performed together.

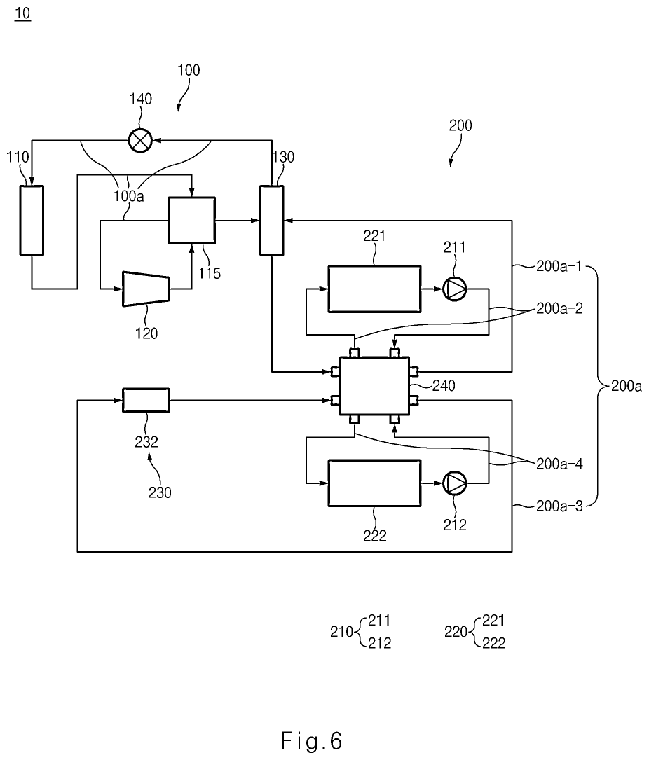

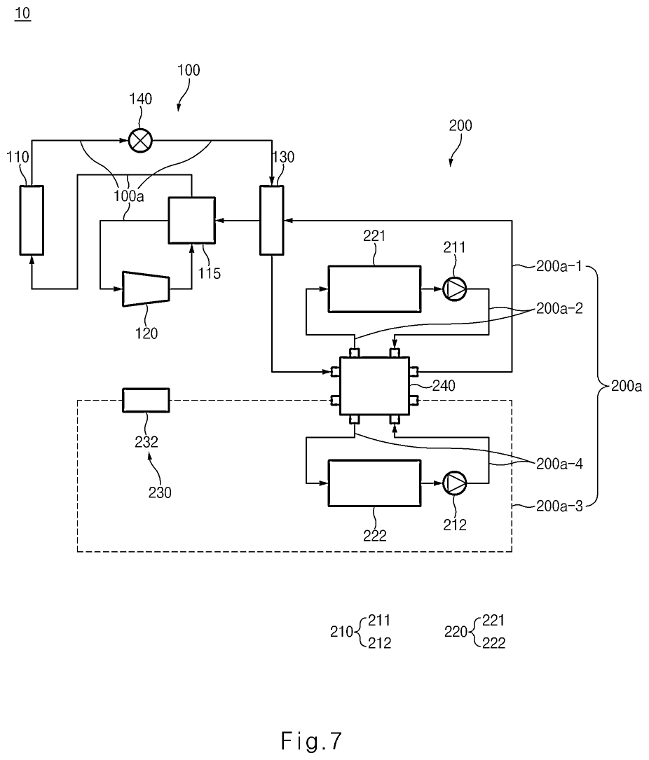

FIG. 5 is a view illustrating a circulation path of a fluid when one of the first hydrogen storage part and the second hydrogen storage part is heated and the other is cooled in a two-side heat exchange mode of a hydrogen supply method according to a second embodiment of the present disclosure. FIG. 6 is a view illustrating a circulation path of a fluid when the first hydrogen storage part and the second hydrogen storage part are heated in the two-side heat exchange mode of the hydrogen supply method according to the second embodiment of the present disclosure. FIG. 7 is a view illustrating a circulation path of a fluid when the first hydrogen storage part and the second hydrogen storage part are cooled in the one-side heat exchange mode of the hydrogen supply method according to the second embodiment of the present disclosure.

The hydrogen supply method according to the second embodiment of the present disclosure is the same as the hydrogen supply method according to the first embodiment of the present disclosure in that it includes the two-side heat exchange mode and the one-side heat exchange mode described above. However, the second embodiment of the present disclosure is different from the first embodiment of the present disclosure in an aspect of the flow direction of the first fluid that circulates in the first fluid circulation line and the function of the thermal device 230. Hereinafter, a difference of the second embodiment of the present disclosure from the first embodiment of the present disclosure is described.

The two-side heat exchange mode of the hydrogen supply method according to the second embodiment may include a (1-2)-th fluid circulation operation of the first fluid sequentially circulating in the first heat exchanger 110, the expansion member 140, the second heat exchanger 130, and the compressor 120 through the first fluid circulation line 100a. The two-side heat exchange mode of the hydrogen supply method according to the second embodiment may also include a (2-1)-th fluid circulation operation of the second fluid being introduced into the second heat exchanger 130 through the (2-1)-th fluid circulation line 200a-1 to exchange heat with the first fluid so as to be cooled and then being introduced into the first hydrogen storage part 221 through the (2-2)-th fluid circulation line 200a-2 to cool the first hydrogen storage part 221. The two-side heat exchange mode of the hydrogen supply method according to the second embodiment may further include a (2-2)-th fluid circulation operation of the second fluid being introduced into the thermal device 230 through the (2-3)-th fluid circulation line 200a-3 to be heated and then being introduced into the second hydrogen storage part 222 through the (2-4)-th fluid circulation line 200a-4 to heat the second hydrogen storage part 222. Thus, according to the second embodiment of the present disclosure, the thermal device 230 may be a heating member 232.

Similar to the first embodiment of the present disclosure, in the second embodiment of the present disclosure, one of the first hydrogen storage part 221 and the second hydrogen storage part 222 may be heated in the (2-1)-th fluid circulation operation and the (2-2)-th fluid circulation operation and the other may be cooled. However, the second embodiment is different from the first embodiment in that the second fluid is heated in the thermal device 230 whereas the second fluid is cooled in the second heat exchanger 130 through the (1-2)-th fluid circulation operation.

Further, similar to the first embodiment of the present disclosure, in the second embodiment of the present disclosure, the (2-1)-th fluid circulation operation and the (2-2)-th fluid circulation operation are performed while time-sequentially overlapping each other. For example, the (2-1)-th fluid circulation operation and the (2-2)-th fluid circulation operation may be performed at the same time. Accordingly, because the first hydrogen storage part 221 is cooled while the (2-1)-th fluid circulation operation and the (2-2)-th fluid circulation operation are performed together, the first hydrogen storage part 221 may perform an hydrogen storage part cooling operation and a hydrogen adsorbing operation as described below. Further, because the second hydrogen storage part 222 is heated at the same time, the second hydrogen storage part 222 may perform a hydrogen storage part heating operation and a hydrogen desorbing operation as described below.

Referring now to FIG. 5, the two-side heat exchange mode according to the second embodiment of the present disclosure may further include a (2-3)-th fluid circulation operation of the second fluid being introduced into the second heat exchanger 130 through the (2-1)-th fluid circulation line 200a-1 to exchange heat with the first fluid so as to be cooled and then being introduced into the second hydrogen storage part 222 through the (2-4)-th fluid circulation line 200a-4 to cool the second hydrogen storage part 222. The two-side heat exchange mode according to the second embodiment of the present disclosure may also include a (2-4)-th fluid circulation operation of the second fluid being introduced into the thermal device 230, in more detail, into the heating member 232 through the (2-3)-th fluid circulation line 200a-3 to be heated and then being introduced into the first hydrogen storage part 221 through the (2-2)-th fluid circulation line 200a-2 to heat the first hydrogen storage part 221.

The (2-3)-th fluid circulation operation and the (2-4)-th fluid circulation operation may be performed in a time-sequentially overlapping manner. For example, the (2-3)-th fluid circulation operation and the (2-4)-th fluid circulation operation may be performed at the same time. Accordingly, because the first hydrogen storage part 221 is heated while the (2-3)-th fluid circulation operation and the (2-4)-th fluid circulation operation are performed together, the first hydrogen storage part 221 may perform an hydrogen storage part heating operation and a hydrogen desorbing operation described below. Further, because the second hydrogen storage part 222 is cooled at the same time, the second hydrogen storage part 222 may perform a hydrogen storage part cooling operation and a hydrogen adsorbing operation described below.

The (2-3)-th fluid circulation operation and the (2-4)-th fluid circulation operation in the second embodiment of the present disclosure may be performed after the (2-1)-th fluid circulation operation and the (2-2)-th fluid circulation operation. Accordingly, according to embodiment of the present disclosure, a process of cooling the second hydrogen storage part 222 while the first hydrogen storage part 221 and a process of heating the second hydrogen storage part 222 while the first hydrogen storage part 221 is cooled may be repeatedly performed, and thus, the hydrogen may be consistently supplied to an external source of demand.

In the second embodiment of the present disclosure, the two-side heat exchange mode and the one-side heat exchange mode may include an operation for heating both of the first hydrogen storage part 221 and the second hydrogen storage part 222.

For example, as illustrated in FIG. 6, the two-side heat exchange mode according to the second embodiment of the present disclosure may include a (1-1)-th fluid circulation operation of the first fluid sequentially circulating in the first heat exchanger 110, the compressor 120, the second heat exchanger 130, and the expansion member 140 through the first fluid circulation line 200a-1. The two-side heat exchange mode according to the second embodiment of the present disclosure may also include a (2-5)-th circulation operation of the second fluid being introduced into the second heat exchanger 130 through the (2-1)-th fluid circulation line 200a-1 to exchange heat with the first fluid to be heated and then being introduced into the first hydrogen storage part 221 or the second hydrogen storage part 222 through the (2-2)-th fluid circulation line 200a-2 or the (2-4)-th fluid circulation line 200a-4 to heat the first hydrogen storage part 221 or the second hydrogen storage part 222. The two-side heat exchange mode according to the second embodiment of the present disclosure may additionally include a (2-6)-th circulation operation of the second fluid being heated in the thermal device 230 through the (2-3)-th fluid circulation line 200a-3 and then being introduced into the first hydrogen storage part 221 or the second hydrogen storage part 222 through the (2-2)-th fluid circulation line 200a-2 or the (2-4)-th fluid circulation line 200a-4 to heat the first hydrogen storage part 221 or the second hydrogen storage part 222. Accordingly, according to the (1-1)-th fluid circulation operation, the (2-5)-th fluid circulation operation, and the (2-6)-th fluid circulation operation of the second embodiment of the present disclosure, the first hydrogen storage part 221 and the second hydrogen storage part 222 may be heated by the second fluid heated in the second heat exchanger 130 and the thermal device 230, respectively.

Meanwhile, the heating of the first hydrogen storage part 221 and the second hydrogen storage part 222, unlike in the process described above, may also be performed in the one-side heat exchange mode.

For example, the one-side heat exchange mode according to the second embodiment of the present disclosure may further include a (1-1)-th fluid circulation operation of the first fluid sequentially circulating in the first heat exchanger 110, the compressor 120, the second heat exchanger 30, and the expansion member 140 through the first fluid circulation line 200a-1. The one-side heat exchange mode according to the second embodiment of the present disclosure may also include a (2-7)-th circulation operation of the second fluid being introduced into the second heat exchanger 130 through the (2-1)-th fluid circulation line 200a-1 to exchange heat with the first fluid to be heated and then being introduced into the first hydrogen storage part 221 and the second hydrogen storage part 222 through the (2-2)-th fluid circulation line 200a-2 and the (2-4)-th fluid circulation line 200a-4 to heat the first hydrogen storage part 221 and the second hydrogen storage part 222. In the (2-7)-th fluid circulation operation, the flow of the second fluid may be substantially stopped in the (2-3)-th fluid circulation line 200a-3 and the driving of the thermal device 230 may be stopped. The heating of the second fluid may thus not be substantially performed in the thermal device 230, or more specifically in the heating member 232. Accordingly, in the (2-7)-th fluid circulation operation of the one-side heat exchange mode, the second fluid may be supplied to the first hydrogen storage part 221 and the second hydrogen storage part 222 after being heated in the second heat exchanger 130, and thus, the heating of the first hydrogen storage part 221 and the second hydrogen storage part 222 may be performed together.

Furthermore, the second embodiment of the present disclosure may include a (2-8)-th circulation operation of the second fluid being heated in the thermal device 230 through the (2-3)-th fluid circulation line 200a-3 and then being introduced into the first hydrogen storage part 221 and the second hydrogen storage part 222 through the (2-2)-th fluid circulation line 200a-2 and the (2-4)-th fluid circulation line 200a-4 to heat the first hydrogen storage part 221 and the second hydrogen storage part 222. In the (2-8)-th fluid circulation operation, the flows of the first fluid in the first fluid circulation line 100a and the second fluid in the (2-1)-th fluid circulation line 200a-1 may be substantially stopped. The heating of the second fluid in the second heat exchanger 130 may thus not be substantially performed as the driving of the compressor 120 is stopped. Accordingly, in the (2-8)-th fluid circulation operation of the one-side heat exchange mode, the second fluid may be supplied to the first hydrogen storage part 221 and the second hydrogen storage part 222 after being heated in the thermal device 230. Thus, the heating of the first hydrogen storage part 221 and the second hydrogen storage part 222 may be performed together.

According to the second embodiment of the present disclosure, the one-side heat exchange mode may include an operation for cooling both of the first hydrogen storage part 221 and the second hydrogen storage part 222.

For example, as illustrated in FIG. 7, the one-side heat exchange mode in the hydrogen supply method according to the second embodiment of the present disclosure may further include a (1-2)-th fluid circulation operation of the first fluid sequentially circulating in the first heat exchanger 110, the expansion member 140, the second heat exchanger 130, and the compressor 120 through the first fluid circulation line 100a. The one-side heat exchange mode in the hydrogen supply method according to the second embodiment of the present disclosure may also include a (2-9)-th circulation operation of the second fluid being introduced into the second heat exchanger 130 through the (2-1)-th fluid circulation line 200a-1 to exchange heat with the first fluid to be cooled and then being introduced into the first hydrogen storage part 221 and the second hydrogen storage part 222 through the (2-2)-th fluid circulation line 200a-2 and the (2-4)-th fluid circulation line 200a-4 to cool the first hydrogen storage part 221 and the second hydrogen storage part 222. In the (2-9)-th fluid circulation operation, the flow of the second fluid may be substantially stopped in the (2-3)-th fluid circulation line 200a-3 and the driving of the thermal device 230 may be stopped. The heating of the second fluid may thus not be substantially performed in the thermal device 230, or more specifically in the heating member 232. Accordingly, in the (2-9)-th fluid circulation operation of the one-side heat exchange mode, the second fluid may be supplied to the first hydrogen storage part 221 and the second hydrogen storage part 222 after being cooled in the second heat exchanger 130. Thus, the cooling of the first hydrogen storage part 221 and the second hydrogen storage part 222 may be performed together.

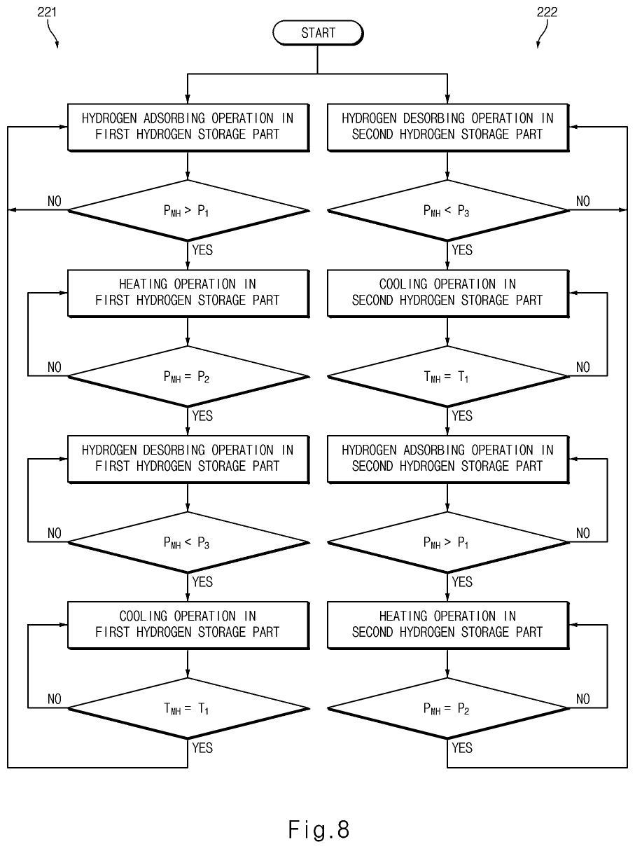

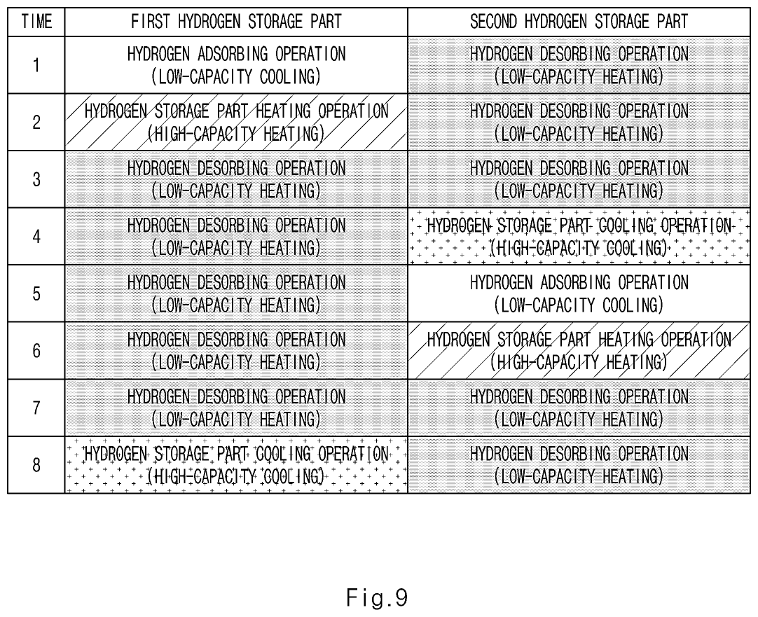

FIG. 8 is a flowchart time-sequentially illustrating a process of performing a hydrogen adsorbing operation, a hydrogen storage part heating operation, a hydrogen desorbing operation, and a hydrogen storage part cooling operation, according to an embodiment of the present disclosure. FIG. 9 is a view illustrating an example of time-sequentially listing sequences of performing the hydrogen adsorbing operation, the hydrogen storage part heating operation, the hydrogen desorbing operation, and the hydrogen storage part cooling operation in the first hydrogen storage part and the second hydrogen storage part in a hydrogen supply method according to an embodiment of the present disclosure.

Referring to FIGS. 1 and 8, the hydrogen supply method according to an embodiment may further include a hydrogen adsorbing operation of the second fluid being discharged from the thermal device 230 in the (2-2)-th fluid circulation operation, being introduced into the hydrogen storage part 220, and being cooled to the metal or the alloy such that the hydrogen is adsorbed to the metal or the alloy in the hydrogen storage part 220. The hydrogen supply method may also include a hydrogen storage part heating operation, which may be performed after the hydrogen adsorbing operation, of the second fluid being discharged from the second heat exchanger 130 in the (2-1)-th fluid circulation operation, and being introduced into the hydrogen storage part 220 to heat the hydrogen storage part 220. The hydrogen supply method may additionally include a hydrogen desorbing operation, which may be performed after the hydrogen storage part heating operation, of discharging from the second heat exchanger 130 in the (2-1)-th fluid circulation operation, being introduced into the hydrogen storage part 220 to heat the hydride so as to desorb the hydrogen from the hydride in the hydrogen storage part 220. The hydrogen supply method may further include a hydrogen storage part cooling operation, which may be performed after the hydrogen desorbing operation, of the second fluid being discharged from the thermal device 230 in the (2-2)-th fluid circulation operation and then being introduced into the hydrogen storage part 220 to cool the hydrogen storage part. Furthermore, the above-described hydrogen adsorbing operation may be performed after the hydrogen storage part cooling operation whereby the hydrogen adsorbing operation, the hydrogen storage part heating operation, the hydrogen desorbing operation, and the hydrogen storage part cooling operation may be performed circularly.

As an example, in the hydrogen adsorbing operation, an amount of the hydrogen in the hydrogen storage part may increase. This may be because the hydrogen is adsorbed while the hydrogen is supplied from the outside into the hydrogen storage part in the hydrogen adsorbing operation. In the hydrogen storage part heating operation that is performed after the hydrogen adsorbing operation, a temperature of the hydrogen storage part may increase and an amount of the hydrogen in the hydrogen storage part may be constant. This may be because the hydrogen in the hydrogen storage part is not discharged to the outside, but on the other hand, the hydrogen also is not supplied from the outside to the hydrogen storage part in the hydrogen storage part heating operation. The hydrogen storage part heating operation may thus be a process of raising temperatures of the hydrogen storage part and the hydride in advance such that a temperature condition in which the hydrogen is smoothly desorbed is created in the hydrogen desorbing operation that is performed later.

In the hydrogen desorbing operation that is performed after the hydrogen storage part heating operation, an amount of the hydrogen in the hydrogen storage part may decrease. This may be because the hydrogen in the hydrogen storage part is discharged to the outside in the hydrogen desorbing operation.

In the hydrogen storage part cooling operation that is performed after the hydrogen desorbing operation, a temperature of the hydrogen storage part may decrease and an amount of the hydrogen in the hydrogen storage part may be constant. This may be because the hydrogen in the hydrogen storage part is not discharged to the outside, but on the other hand, the hydrogen is not supplied from the outside to the hydrogen storage part in the hydrogen storage part cooling operation. The hydrogen storage part cooling operation may thus be a process of decreasing temperatures of the hydrogen storage part and the metal or the alloy in advance such that a temperature condition in which the hydrogen is smoothly desorbed is created in the hydrogen adsorbing operation that is performed later.

Ss illustrated in FIGS. 1 and 8, in the hydrogen supply method according to embodiments of the present disclosure, when a pressure (P_{MH}) of the metal or the alloy in the hydrogen storage part 220 becomes higher than a specific value P₁ in the hydrogen adsorbing operation, the hydrogen adsorbing operation may be completed, and the hydrogen storage part heating operation may be started. Furthermore, when a pressure P_{MH} of the hydride in the hydrogen storage part 220 reaches a specific value P₂ in the hydrogen storage part heating operation, the hydrogen storage part heating operation may be completed, and the hydrogen desorbing operation may be started. Furthermore, when a pressure P_{MH} of the hydride in the hydrogen storage part becomes lower than a specific value P₃ in the hydrogen desorbing operation, the hydrogen desorbing operation may be completed, and the hydrogen storage part cooling operation may be started. Furthermore, when a temperature T_{MH} of the metal or the alloy in the hydrogen storage part 220 reaches a specific value T₁ in the hydrogen storage part cooling operation, the hydrogen storage part cooling operation may be completed, and the hydrogen adsorbing operation may be started again.

FIG. 9 is a view illustrating an example of time-sequentially listing sequences of performing the hydrogen adsorbing operation, the hydrogen storage part heating operation, the hydrogen desorbing operation, and the hydrogen storage part cooling operation in the first hydrogen storage part and the second hydrogen storage part in the hydrogen supply method according to an embodiment of the present disclosure. However, the sequence illustrated in FIG. 9 is merely an example. The scope of the present disclosure is not limited by the illustration of FIG. 9.

As illustrated in FIG. 9, the hydrogen supply method according to an embodiment of the present disclosure may include: i) a first time period (time 1 of FIG. 9) in which the metal or the alloy in the first hydrogen storage part is cooled and the hydride in the second hydrogen storage part is heated, ii) a second time period (time 2 of FIG. 9) in which the first hydrogen storage part is heated and the hydride in the second hydrogen storage part is heated, iii) a third time period (time 3 of FIG. 9) in which the hydride in the first hydrogen storage part and the hydride in the second hydrogen storage part are heated together, iv) a fourth time period (time 4 of FIG. 9) in which the hydride in the first hydrogen storage part is heated and the second hydrogen storage pat is cooled, v) a fifth time period (time 5 of FIG. 9) in which the hydride in the first hydrogen storage part is heated and the metal or the alloy in the second hydrogen storage part is cooled, vi) a sixth time period (time 6 of FIG. 9) in which the hydride in the first hydrogen storage part is heated and the second hydrogen storage part is heated, vii) a seventh time period (time 7 of FIG. 9) in which the hydride in the first hydrogen storage part and the hydride in the second hydrogen storage part are heated together, and vii) an eighth time period (time 8 of FIG. 9) in which the first hydrogen storage part is cooled and the hydride in the second hydrogen storage part is heated, may be repeated. According to embodiments of the present disclosure, the two-side heat exchange mode and the one-side heat exchange mode described above are repeated and the flow direction and the flow rate of the second fluid are controlled by the second flow rate control member 240 whereby the first time period to the eight time period described above may be repeated. Thus, the hydrogen may be consistently supplied from the first hydrogen storage part and the second hydrogen storage part to an external source of demand.

Embodiments of the present disclosure provide a hydrogen storage system of a new form that may replace a hydrogen storage system that directly compresses hydrogen.

Although the present disclosure has been described with reference to the example embodiments and the accompanying drawings, the present disclosure is not limited thereto. The present disclosure may be variously carried out by those having ordinary skill in the art to which this disclosure pertains, without departing from the scope and the technical spirit of the present disclosure. The scope of the present disclosure is determined by the appended claims, and all technical ideas within the range equivalent to the claims should be interpreted as being included in the scope of the present disclosure.

What is claimed is:

1. A hydrogen supply module comprising:
a first circulation part including a first fluid circulation line in which a first fluid circulates; and
a second circulation part including a second fluid circulation line, in which a second fluid circulates;
wherein the first fluid circulation part includes:
a first heat exchanger in which the first fluid exchanges heat with an external fluid,
a first flow rate control member connected to the first heat exchanger through the first fluid circulation line and configured to control flows of the first fluid,
a compressor connected to the first flow rate control member through the first fluid circulation line and configured to compress the first fluid,
a second heat exchanger connected to the first flow rate control member through the first fluid circulation line, and
an expansion member connected to the second heat exchanger through the first fluid circulation line and configured to expand the first fluid;
wherein the second fluid circulation line is connected to the second heat exchanger such that the first fluid and the second fluid exchange heat in the second heat exchanger;
wherein the second fluid circulation part includes:
a pump connected to the second heat exchanger through the second fluid circulation line and configured to pump the second fluid,
a hydrogen storage part connected to the second heat exchanger through the second fluid circulation line and including a metal or an alloy that absorbs hydrogen, and
a second flow rate control member provided on the second fluid circulation line and configured to control flows of the second fluid that flows on the second fluid circulation line; and
wherein the hydrogen storage part includes:
a first hydrogen storage part provided on the second fluid circulation line, and
a second hydrogen storage part provided on the second fluid circulation line and connected to the first hydrogen storage part through the second fluid circulation line while the second flow rate control member is interposed therebetween.

2. The hydrogen supply module of claim 1, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one end and an opposite end of the second flow rate control member and having a closed loop shape, and
a (2-4)-th fluid circulation line connecting the second hydrogen storage part and the second flow rate control member and having a closed loop shape; and
wherein the second flow rate control member is configured to:
control flow directions of the second fluid in the (2-1)-th fluid circulation line, the (2-2)-th fluid circulation line, and the (2-3)-th fluid circulation line, and the (2-4)-th fluid circulation line.

3. The hydrogen supply module of claim 2, wherein the pump includes:
a first pump provided on the (2-2)-th fluid circulation line, and
a second pump provided on the (2-4)-th fluid circulation line.

4. The hydrogen supply module of claim 1, wherein a first side and a second side of the first flow rate control member are connected to the compressor through the first fluid circulation line, and
wherein the first fluid circulation part is configured to:
control the flows of the first fluid such that the first fluid 1) sequentially passes through the first flow rate control member, the compressor, the first flow rate control member, and the second heat exchanger, or ii) sequentially passes through the first flow rate control member, the compressor, the first flow rate control member, and the first heat exchanger.

5. The hydrogen supply module of claim 2, wherein the second fluid circulation part further includes:
a thermal device provided on the (2-3)-th fluid circulation line and configured to heat or cool the second fluid, and
wherein the thermal device is a heat dissipating member that cools the second fluid.

6. The hydrogen supply module of claim 2, wherein the second fluid circulation part further includes:
a thermal device provided on the (2-3)-th fluid circulation line and configured to heat or cool the second fluid, and
wherein the thermal device is a heating member that heats the second fluid.

7. A hydrogen supply method using a hydrogen supply module that includes a first circulation part including a first fluid circulation line in which a first fluid circulates and a second circulation part including a second fluid circulation line in which a second fluid circulates, wherein the second fluid circulation part includes a thermal device provided on the second fluid circulation line, the hydrogen supply method comprising:
preforming, in a two-side heat exchange mode, both of i) introducing the second fluid into a hydrogen storage part after the second fluid exchanges heat with the first fluid in a second heat exchanger in a state in which the compressor is driven to compress the first fluid and ii) introducing the second fluid into the hydrogen storage part after the second fluid is heated or cooled in the thermal device; and
performing, in a one-side heat exchange mode, one of i) introducing the second fluid into the hydrogen storage part after the second fluid exchanges heat with the first fluid in the second heat exchanger in a state in which the compressor is driven to compress the first fluid and ii) introducing the second fluid into the hydrogen storage part after the second fluid is heated or cooled in the thermal device,
wherein the two-side heat exchange mode and the one-side heat exchange mode are time-sequentially performed at separate time periods;
wherein the first fluid circulation part of the hydrogen supply module includes:
a first heat exchanger in which the first fluid exchanges heat with an external fluid,
a first flow rate control member connected to the first heat exchanger through the first fluid circulation line and configured to control flows of the first fluid,
a compressor connected to the first flow rate control member through the first fluid circulation line and configured to compress the first fluid,
the second heat exchanger connected to the first flow rate control member through the first fluid circulation line, and
an expansion member connected to the second heat exchanger through the first fluid circulation line and configured to expand the first fluid;
wherein the second fluid circulation line is connected to the second heat exchanger such that the first fluid and the second fluid exchange heat in the second heat exchanger;
wherein the second fluid circulation part of the hydrogen supply module includes:
a pump connected to the second heat exchanger through the second fluid circulation line and configured to pump the second fluid,
a hydrogen storage part connected to the second heat exchanger through the second fluid circulation line and including a metal or an alloy that absorbs hydrogen, and
a second flow rate control member provided on the second fluid circulation line and configured to control flows of the second fluid that flows on the second fluid circulation line;
wherein the hydrogen storage part of the hydrogen supply module includes:
a first hydrogen storage part provided on the second fluid circulation line, and
a second hydrogen storage part provided on the second fluid circulation line and connected to the first hydrogen storage part through the second fluid circulation line while the second flow rate control member is interposed therebetween.

8. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a close loop shape, and the thermal device is provided on the (2-3)-th fluid circulation line; and
wherein the two-side heat exchange mode includes:
a (1-1)-th fluid circulation operation of the first fluid sequentially circulating in the first heat exchanger, the compressor, the second heat exchanger, and the expansion member through the first fluid circulation line,
a (2-1)-th fluid circulation operation of the second fluid being introduced into the second heat exchanger through the (2-1)-th fluid circulation line to exchange heat with the first fluid so as to be heated and then being introduced into the first hydrogen storage part through the (2-2)-th fluid circulation line to heat the first hydrogen storage part, and
a (2-2)-th fluid circulation operation of the second fluid being introduced into the thermal device through the (2-3)-th fluid circulation line to be cooled and then being introduced into the second hydrogen storage part through the (2-4)-th fluid circulation line to cool the second hydrogen storage part.

9. The hydrogen supply method of claim 8, wherein the two-side heat exchange mode further includes:
a (2-3)-th fluid circulation operation of the second fluid being introduced into the second heat exchanger through the (2-1)-th fluid circulation line to exchange heat with the first fluid so as to be heated and then being introduced into the second hydrogen storage part through the (2-4)-th fluid circulation line to heat the second hydrogen storage part, and
a (2-4)-th fluid circulation operation of the second fluid being introduced into the thermal device through the (2-3)-th fluid circulation line to be cooled and then being introduced into the first hydrogen storage part through the (2-2)-th fluid circulation line to cool the first hydrogen storage part;
wherein the (2-1)-th fluid circulation operation and the (2-2)-th fluid circulation operation are performed in a time-sequentially overlapping state,
wherein the (2-3)-th fluid circulation operation and the (2-4)-th fluid circulation operation are performed in a time-sequentially overlapping state, and
wherein the (2-3)-th fluid circulation operation and the (2-4)-th fluid circulation operation are performed after the (2-1)-th fluid circulation operation and the (2-2)-th fluid circulation operation.

10. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member, wherein the thermal device is provided on the (2-3)-th fluid circulation line, and
wherein the one-side heat exchange mode further includes:
a (1-1)-th fluid circulation operation of the first fluid sequentially circulating in the first heat exchanger, the compressor, the second heat exchanger, and the expansion member through the first fluid circulation line, and
a (2-5)-th circulation operation of the second fluid being introduced into the second heat exchanger through the (2-1)-th fluid circulation line to exchange heat with the first fluid to be heated and then being introduced into the first hydrogen storage part and the second hydrogen storage part through the (2-2)-th fluid circulation line and the (2-4)-th fluid circulation line to heat the first hydrogen storage part and the second hydrogen storage part,
wherein in the (2-5)-th fluid circulation operation, flows of the second fluid are substantially stopped in the (2-3)-th fluid circulation line.

11. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line, and
wherein the two-side heat exchange mode includes:
a (1-2)-th fluid circulation operation of the first fluid sequentially circulating in the first heat exchanger, the expansion member, the second heat exchanger, and the compressor through the first fluid circulation line,
a (2-6)-th circulation operation of the second fluid being introduced into the second heat exchanger through the (2-1)-th fluid circulation line to exchange heat with the first fluid to be cooled and then being introduced into the first hydrogen storage part or the second hydrogen storage part through the (2-2)-th fluid circulation line or the (2-4)-th fluid circulation line to cool the first hydrogen storage part or the second hydrogen storage part, and
a (2-7)-th circulation operation of the second fluid being cooled in the thermal device through the (2-3)-th fluid circulation line and then being introduced into the first hydrogen storage part or the second hydrogen storage part through the (2-2)-th fluid circulation line or the (2-4)-th fluid circulation line to cool the first hydrogen storage part or the second hydrogen storage part.

12. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line;
wherein the one-side heat exchange mode includes:
a (1-2)-th fluid circulation operation of the first fluid sequentially circulating in the first heat exchanger, the expansion member, the second heat exchanger, and the compressor through the first fluid circulation line, and
a (2-8)-th circulation operation of the second fluid being introduced into the second heat exchanger through the (2-1)-th fluid circulation line to exchange heat with the first fluid to be cooled and then being introduced into the first hydrogen storage part and the second hydrogen storage part through the (2-2)-th fluid circulation line and the (2-4)-th fluid circulation line to cool the first hydrogen storage part and the second hydrogen storage part, and
wherein in the (2-8)-th fluid circulation operation, flows of the second fluid are substantially stopped in the (2-3)-th fluid circulation line.

13. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line,
wherein the one-side heat exchange mode includes:
a (2-9)-th circulation operation of the second fluid being cooled in the thermal device through the (2-3)-th fluid circulation line and then being introduced into the first hydrogen storage part and the second hydrogen storage part through the (2-2)-th fluid circulation line and the (2-4)-th fluid circulation line to cool the first hydrogen storage part and the second hydrogen storage part, and
wherein in the (2-9)-th fluid circulation operation, the flows of the first fluid in the first fluid circulation line and the second fluid in the (2-1)-th fluid circulation line are substantially stopped.

14. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line; and
wherein the two-side heat exchange mode further includes:
a (1-2)-th fluid circulation operation of the first fluid sequentially circulating in the first heat exchanger, the expansion member, the second heat exchanger, and the compressor through the first fluid circulation line,
a (2-1)-th fluid circulation operation of the second fluid being introduced into the second heat exchanger through the (2-1)-th fluid circulation line to exchange heat with the first fluid so as to be cooled and then being introduced into the first hydrogen storage part through the (2-2)-th fluid circulation line to cool the first hydrogen storage part, and
a (2-2)-th fluid circulation operation of the second fluid being introduced into the thermal device through the (2-3)-th fluid circulation line to be heated and then being introduced into the second hydrogen storage part through the (2-4)-th fluid circulation line to heat the second hydrogen storage part.

15. The hydrogen supply method of claim 14, wherein the two-side heat exchange mode further includes:
a (2-3)-th fluid circulation operation of the second fluid being introduced into the second heat exchanger through the (2-1)-th fluid circulation line to exchange heat with the first fluid so as to be cooled and then being introduced into the second hydrogen storage part through the (2-4)-th fluid circulation line to cool the second hydrogen storage part, and
a (2-4)-th fluid circulation operation of the second fluid being introduced into the thermal device through the (2-3)-th fluid circulation line to be heated and then being introduced into the first hydrogen storage part through the (2-2)-th fluid circulation line to heat the first hydrogen storage part;
wherein the (2-1)-th fluid circulation operation and the (2-2)-th fluid circulation operation are performed in a time-sequentially overlapping state,
wherein the (2-3)-th fluid circulation operation and the (2-4)-th fluid circulation operation are performed in a time-sequentially overlapping state, and
wherein the (2-3)-th fluid circulation operation and the (2-4)-th fluid circulation operation are performed after the (2-1)-th fluid circulation operation and the (2-2)-th fluid circulation operation.

16. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line, and
wherein the two-side heat exchange mode further includes:
a (1-1)-th fluid circulation operation of the first fluid sequentially circulating in the first heat exchanger, the compressor, the second heat exchanger, and the expansion member through the first fluid circulation line,
a (2-5)-th circulation operation of the second fluid being introduced into the second heat exchanger through the (2-1)-th fluid circulation line to exchange heat with the first fluid to be heated and then being introduced into the first hydrogen storage part or the second hydrogen storage part through the (2-2)-th fluid circulation line or the (2-4)-th fluid circulation line to heat the first hydrogen storage part or the second hydrogen storage part, and
a (2-6)-th circulation operation of the second fluid being heated in the thermal device through the (2-3)-th fluid circulation line and then being introduced into the first hydrogen storage part or the second hydrogen storage part through the (2-2)-th fluid circulation line or the (2-4)-th fluid circulation line to heat the first hydrogen storage part or the second hydrogen storage part.

17. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line,
wherein the one-side heat exchange mode further includes:
a (1-1)-th fluid circulation operation of the first fluid sequentially circulating in the first heat exchanger, the compressor, the second heat exchanger, and the expansion member through the first fluid circulation line, and
a (2-7)-th circulation operation of the second fluid being introduced into the second heat exchanger through the (2-1)-th fluid circulation line to exchange heat with the first fluid to be heated and then being introduced into the first hydrogen storage part and the second hydrogen storage part through the (2-2)-th fluid circulation line and the (2-4)-th fluid circulation line to heat the first hydrogen storage part and the second hydrogen storage part, and
wherein in the (2-7)-th fluid circulation operation, flows of the second fluid are substantially stopped in the (2-3)-th fluid circulation line.

18. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line;
wherein the one-side heat exchange mode includes:
a (2-8)-th circulation operation of the second fluid being heated in the thermal device through the (2-3)-th fluid circulation line and then being introduced into the first hydrogen storage part and the second hydrogen storage part through the (2-2)-th fluid circulation line and the (2-4)-th fluid circulation line to heat the first hydrogen storage part and the second hydrogen storage part; and
wherein in the (2-8)-th fluid circulation operation, the flows of the first fluid in the first fluid circulation line and the second fluid in the (2-1)-th fluid circulation line are substantially stopped.

19. The hydrogen supply method of claim 7, wherein the second fluid circulation line includes:
a (2-1)-th fluid circulation line connecting the second heat exchanger and the second flow rate control member and having a closed loop shape,
a (2-2)-th fluid circulation line connecting the first hydrogen storage part and the second flow rate control member and having a closed loop shape,
a (2-3)-th fluid circulation line connecting one side and an opposite side of the second flow rate control member and having a closed loop shape, and
a (2-4)-th fluid circulation line connecting the second hydrogen storage part and the second flow rate control member and having a closed loop shape, and the thermal device is provided on the (2-3)-th fluid circulation line;
wherein the one-side heat exchange mode includes:
a (1-2)-th fluid circulation operation of the first fluid sequentially circulating in the first heat exchanger, the expansion member, the second heat exchanger, and the compressor through the first fluid circulation line, and
a (2-9)-th circulation operation of the second fluid being introduced into the second heat exchanger through the (2-1)-th fluid circulation line to exchange heat with the first fluid to be cooled and then being introduced into the first hydrogen storage part and the second hydrogen storage part through the (2-2)-th fluid circulation line and the (2-4)-th fluid circulation line to cool the first hydrogen storage part and the second hydrogen storage part; and
wherein in the (2-9)-th fluid circulation operation, flows of the second fluid are substantially stopped in the (2-3)-th fluid circulation line.
